(19) United States
(12) Patent Application Publication
(10) Pub. No.: US 2012/0284923 A1
(43) Pub. Date: Nov. 15, 2012

(54) PATIENT TRANSPORTER WITH INFLATABLE CHAMBERS

(75) Inventors: Ronald Jensen, Chicago, IL (US); Richard Beu, Yorba Linda, CA (US); Sayandro Versteylen, Fontana, CA (US)

(73) Assignee: PAPER-PAK INDUSTRIES, Laverne, CA (US)

(21) Appl. No.: 13/521,979

(22) PCT Filed: Jan. 12, 2011
(86) PCT No.: PCT/US11/21028

§ 371 Date: Jul. 12, 2012

Related U.S. Application Data
(60) Provisional application No. 61/294,339, filed on Jan. 12, 2010.
(60) Provisional application No. 61/327,217, filed on Apr. 23, 2010.

(51) Int. Cl. A61G 1/013; A61G 1/007; A61G 1/00

(52) U.S. Cl. 5/627; 5/625

(57) ABSTRACT

A patient transporter having inflatable chambers or channels that provides improved support, rigidity, and height is disclosed. The patient transporter is lightweight, portable and durable. The inflatable chambers also provide buoyancy. A skid plate on the bottom surface of the transporter allows the transporter to be easily pulled over the ground when transporting a person. A hinged support assembly can be connected to the bottom of the transporter for additional rigidity and support. A method for using a patient transporter having inflatable chambers is also provided.

### BACKGROUND OF THE DISCLOSURE

### Field of Disclosure

The present disclosure provides a patient transporter having inflatable chambers that provides support, height, and buoyancy (when inflated) to transport a patient.

### SUMMARY OF THE DISCLOSURE

The present disclosure provides a patient transporter having inflatable chambers that provides improved rigidity and mechanical support (when inflated) to transport a patient.

The inflatable chambers may further provide a degree of buoyancy and extra height to the patient transporter of the present disclosure, thereby further improving patient comfort and reducing the risk of contamination. If buoyancy is sufficiently large, the transporter can float.

When fully inflated, the patient transporter is semi-rigid and flexible, thereby allowing a prescribed amount of deflection from horizontal when a patient is carried thereon that enhances patient comfort and stability during transport.

The inflatable chambers are designed to be quickly inflated or filled with air (or other gas), or by filling the chambers with a lightweight solid or liquid. The inflatable chambers may be filled with a liquid which, upon contact with air (or a second component), forms a gas or foam that fills the inflatable chambers and increases the strength and rigidity of the inflatable structure. A ripcord device or other rapid-activating device can be used with a gas canister of pressurized gas that permits the user to initiate filling of the inflatable chambers with a single pull of a ripcord. The inflatable chambers can also have a device to permit deflation after use.

The patient transporter of the present disclosure can have a top cover and cut-out opening so that the patient's face and head are exposed during transport but the rest of the patient's body is covered to reduce loss of body heat.

Prior to use, the patient transporter of the present disclosure can be rolled up or folded to a small size to fit into a standard-size canister or rucksack and carried by a single soldier, medic, emergency medical technician, and/or stretcher bearer. The patient transporter is also considerably lighter in total weight than conventional litters.

The patient transporter of the present disclosure can be made without any metal structures, or with a non-metallic coating around metal parts, to reduce the risk of detection in a hostile environment.

The present disclosure also provides a method of using a patient transporter having inflatable chambers that provide improved rigidity, mechanical support, height, and/or buoyancy to the patient transporter, as well as a method for manufacturing the patient transporter.

### BRIEF DESCRIPTION OF THE DRAWINGS

FIG. 1 is a perspective view of an exemplary embodiment of a patient transporter of the present disclosure having inflatable chambers forming a substrate that is connected to the bottom side of the upper substrate in a horizontal configuration (inflatable chambers are inflated).

FIG. 2A is cross-sectional view of FIG. 1 along axis A-A, where the inflatable chambers are inflated. FIG. 2B is a cross-sectional view of FIG. 1 along axis A-A, where the inflatable chambers are inflated and enclosed in an exterior cover.

FIG. 3 is a perspective view of another exemplary embodiment of a patient transporter of the present disclosure having inflatable chambers forming a substrate that is connected to the bottom side of the upper substrate in a vertical configuration (inflatable chambers are inflated).

FIG. 4 is a perspective view of an exemplary embodiment of a patient transporter, having a top cover and a cut-out opening to fit around a patient's face and head.

FIG. 5 is a perspective view of the top portion of another exemplary embodiment of a patient transporter of the present disclosure, having a top cover, a cut-out opening to fit around the patient's face and head, and a closure device that is configured to permit easy access for the patient.

FIG. 6 is perspective view of another exemplary embodiment of a patient transporter of the present disclosure, having a black nylon top cover, a reflective thermal liner on the underside of the top layer, cut-out opening and collar to fit around the patient's face and head.

FIG. 7 is a top view of yet another exemplary embodiment of a patient transporter of the present disclosure, having a top cover with a cut-out opening to fit around a patient's face and head, a closure device in a curved configuration from a widthwise edge to the opposite edge, bindings, and carrying handles.

FIG. 8 is a cross-section along axis B-B of a portion of the patient transporter in FIG. 7, showing the top cover, thermal liner, absorbent core, inflatable chamber, and exterior cover.

FIG. 9 is an end view of the patient transporter in FIG. 7 viewed from the “foot” end, showing the end handles, side handles, top cover, and closure of the patient transporter.

FIG. 10 is a perspective view of the bottom side of still another exemplary embodiment of a patient transporter of the present disclosure, having a fill valve in the foreground and gripping devices (handles) formed by securing straps extending across the bottom side of the patient transporter.

FIG. 11 is an enlarged view of a portion of the bottom surface of the patient transporter in FIG. 10, to show the details of the fill valve and gripping device (handle).

FIG. 12 is a bottom view of another exemplary embodiment of a patient transporter of the present disclosure, showing a ripcord device, regulator, and gas canister, a fill valve, and gripping handles formed by straps extending widthwise across the bottom surface of the patient transporter.

FIG. 13 is a bottom view of an exemplary embodiment of a lower substrate of the present disclosure that is a single, continuous inflatable chamber in a vertical configuration (i.e., parallel to the direction of a patient's body on the patient transporter).

FIG. 14 is a bottom view of another exemplary embodiment of a lower substrate of the present disclosure that is a single, continuous inflatable chamber in a horizontal configuration (i.e., perpendicular to the direction of a patient's body on the patient transporter).

FIG. 15 is a bottom view of still another exemplary embodiment of a lower substrate of the present disclosure having discrete inflatable chambers arranged in a vertical configuration.

FIG. 16 is a bottom view of yet another exemplary embodiment of a lower substrate of the present disclosure having discrete inflatable chambers arranged in a horizontal configuration.

FIG. 17 is a perspective view of the bottom side of an exemplary embodiment of the patient transporter of the present disclosure, having a lower substrate formed by multiple, discrete inflatable chambers arranged adjacently in a horizontal configuration, having an individual fill valve for each inflatable chamber.

FIG. 18 is a perspective view of the bottom side of the exemplary embodiment of the patient transporter in FIG. 17, with a patient being carried thereon.

FIG. 19 is a front view of an exemplary embodiment of a ripcord device that is activated manually by a user by a single pull to release gas from a gas canister that rapidly inflates the inflatable chambers of a patient transporter of the present disclosure.

FIG. 20 is a front view of another exemplary embodiment of a ripcord device having an auto-firing feature to activate a gas canister to inflate the inflatable chambers of a patient transporter of the present disclosure.

FIG. 21A is a further exemplary embodiment of a ripcord device that has an auto-firing capability to activate a gas canister that inflates the inflatable chambers of a patient transporter of the present disclosure.

FIG. 21B is an exploded view of the components in the ripcord device in FIG. 21A.

FIG. 22 is a perspective view of one type of material that can be used in the manufacture of an inflatable chamber for a patient transporter of the present disclosure, shown with open edges prior to sealing to reveal the interior cavity formed between a double-walled structure.

FIG. 23 is a perspective view of another type of material that can be used in the manufacture of an inflatable chamber for a patient transporter of the present disclosure, shown with open edges prior to sealing to reveal the interior cavity formed between a double-walled structure.

FIG. 24 is a side view of the material in FIG. 22, representing the interior structure of the inflatable chamber when air is introduced, showing inflation only to the height that the interior attachment fibers allow.

FIG. 25 is a side view of the material in FIG. 23, representing the interior structure of the inflatable chamber when air is introduced to the sealed edge structure, showing inflation only to the height that the interior attachment fibers allow.

FIG. 26 is a bottom view of an exemplary embodiment of a lower substrate of the present disclosure having a skid plate (material segment) connected to the lower substrate.

FIGS. 27A-27C are perspective views of an exemplary embodiment of a hinged support assembly of the present disclosure in a closed, partially-open, and open configuration, respectively.

FIGS. 28A and 28B are bottom views of another exemplary embodiment of a hinged support assembly in a closed and in an open configuration, respectively, with an arrow in FIG. 28A indicating the direction of opening the solid segment to form the open configuration in FIG. 28B.

FIG. 29 is a bottom view of an exemplary embodiment of a hinged support assembly on the underside of a patient transporter of the present disclosure.

FIG. 30 is a bottom view of an exemplary embodiment of a dual hinged support assembly with two cross-segments in an open configuration, with an arrow indicating the direction of closing.

FIG. 31 is a bottom view of an exemplary embodiment of a dual hinged support assembly with cross-segments on the underside of a patient transporter of the present disclosure.

FIG. 32 illustrates a cross-section of the layers from top to bottom of another exemplary embodiment of a patient transporter having a hinged support assembly.

FIGS. 33A and 33B represent the top view of the back and front sides, respectively, of another exemplary embodiment of a patient transporter of the present disclosure, having two channels that are integral to the upper substrate of the patient transporter that can be inflated (or through which poles may be passed) for rigidity and mechanical support.

FIGS. 34A and 34B represent the top view of the back and front sides, respectively, of another exemplary embodiment of a patient transporter of the present disclosure, having six channels that are integral to the upper substrate of the patient transporter that can be inflated (or through which poles may be passed) for rigidity and mechanical support.

FIG. 35 is a perspective view of another exemplary embodiment of the patient transporter of the present disclosure having inflatable tubes that are sewn in the patient transporter, and arranged in a horizontal configuration.

FIG. 36 is a perspective view showing the top of another exemplary embodiment of a patient transporter of the present disclosure having inflatable tubes that are integrated in the upper substrate, in an uninflated condition.

FIG. 37 is a perspective view of the patient transporter of FIG. 36 that is folded for greater portability, and the inflatable chambers are shown in an uninflated condition.

FIG. 38 is a perspective view of another exemplary embodiment of a patient transporter of the present disclosure, having a plurality of inflatable chambers in that are inflated to different levels to provide zones of greater or lesser rigidity and mechanical support.

FIG. 39 is a top view of a portion of another exemplary embodiment of a patient transporter of the present disclosure, with a head support within the main footprint of the patient transporter that is supported by inflatable chambers extending across the width of the patient transporter.

FIG. 40 is a left side view of the patient transporter in FIG. 39.

### DETAILED DESCRIPTION OF THE DISCLOSURE

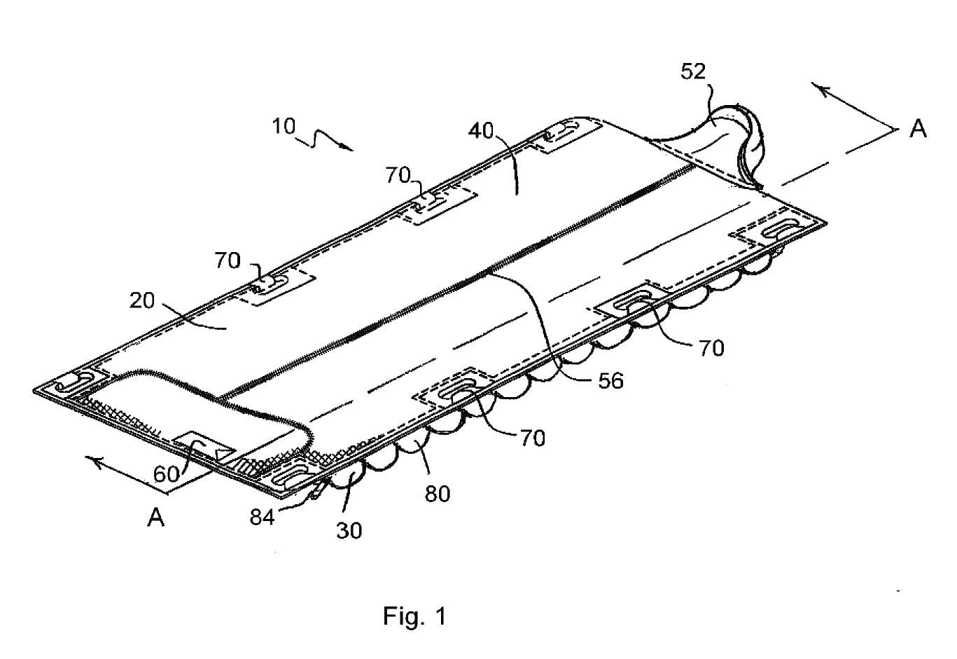

Referring to the drawings, and in particular, FIG. 1, there is provided a patient transporter of the present disclosure generally represented by reference numeral 10. Patient transporter 10 has an upper substrate 20 and a lower substrate 30 that is connected to a bottom side of upper substrate 20.

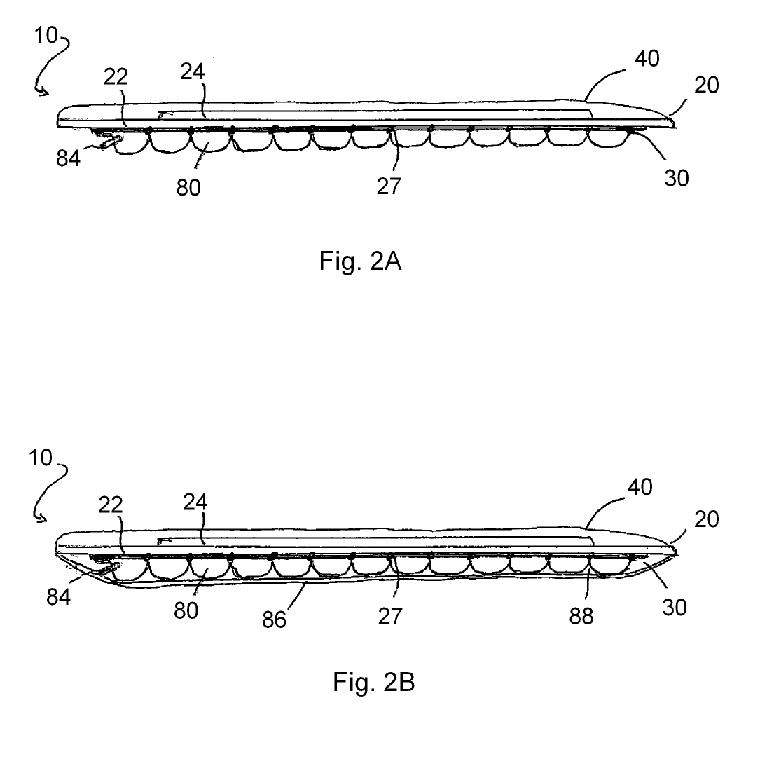

Upper substrate 20 has a top side and a bottom side. The top side of upper substrate 20 can have a top cover 40 that can be closed by closure device 56, such as a zipper. The bottom side of upper substrate 20 is formed by a backing substrate 22 (shown in FIG. 2). Upper substrate 20 can have an absorbent body 24 that is disposed on a top surface of backing substrate 22 (also shown in FIG. 2). In other embodiments, upper substrate 20 has a bottom side that is formed by backing substrate 22, but does not have top cover 40 and/or absorbent body 24. Upper substrate 20 can also have a pocket 60, to hold medical paperwork, identification information, medications, clothing, and personal items.

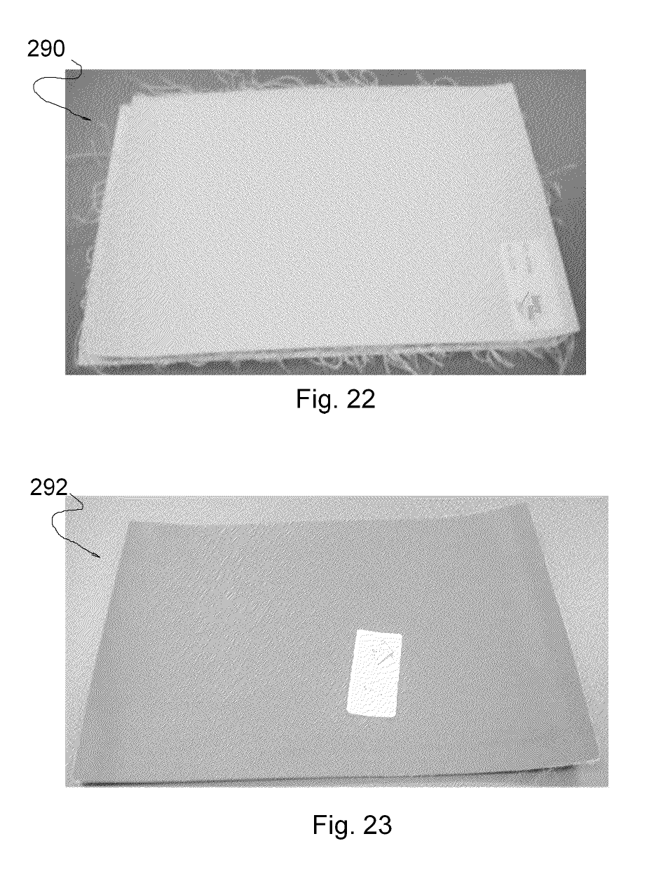

Upper substrate 20 has one or more gripping devices 70 positioned around the perimeter of patient transporter 10, to permit patient transporter 10 to be easily gripped and moved (by lifting or pulling) by a person or persons who are carrying the patient on the transporter. Upper substrate 20 may also have a head cover 52 that is permanently or removably connected to the upper edge of upper substrate 20. As an alternative to head cover 52, a further embodiment (shown in FIGS. 21 and 22) provides a head support 752 that is placed on top of patient transporter 710 within the main, overall rectangular footprint of patient transporter 710.

Lower substrate 30 has one or more inflatable chambers 80 that extend widthwise or lengthwise across patient transporter 10. In the embodiment in FIG. 1, lower substrate 30 has inflatable chambers 80 in a horizontal configuration that extend from a lengthwise edge to the opposite lengthwise edge of patient transporter 10. In another embodiment, lower substrate 30 has an exterior cover 86 (shown in FIG. 2B) that is connected to upper substrate 20 to form a pocket 88 that completely encloses inflatable chambers 80.

At least one inflatable chamber 80 may also be positioned under head cover 52 (not visible in FIG. 1), to provide support for the head and neck of the patient during transport. In an exemplary embodiment, the inflatable chambers 80 may be arranged in a “V-shaped” or “U-shaped” configuration under head cover 52, to comfortably support the head and neck. Alternatively, in another embodiment (shown in FIGS. 21 and 22), a head support 752 may be placed on top of patient transporter 710, within its main rectangular footprint, that is supported by one or more inflatable chambers 780 extending across the width and/or length of patient transporter 710.

FIG. 2A is a cross-section along axis A-A of the exemplary embodiment of patient transporter 10 in FIG. 1. Upper substrate 20 includes top cover 40, a backing substrate 22 connected to top cover 40, and an absorbent body 24 therebetween, that is connected to backing substrate 22. Lower substrate 30 is connected to the bottom side of upper substrate 20, which is formed by backing substrate 22. In a preferred embodiment, upper substrate 20 and lower substrate 30 are connected at seal points 27 by Radio Frequency (RF) welding to form inflatable chambers 80 and/or pleats for additional strength and support. In other embodiments, lower substrate 30 can be connected to upper substrate 20 using heat wedge, adhesive, and/or ultrasonic technologies. In the embodiment of FIG. 2A, inflatable chambers 80 are assembled in a horizontal configuration; i.e., arranged perpendicularly to the direction of a patient's body on patient transporter 10. However, in an alternative embodiment, inflatable chambers 80 can be arranged in a vertical configuration, or at oblique angles, relative to the direction of the patient's body on patient transporter 10.

The inflatable chambers of the present disclosure may be configured vertically, horizontally, and/or at any angle relative to the direction of the patient's body, to provide the desired degree of support. The inflatable chambers can be a plurality of discrete inflatable chambers that are adjacent each other, or a single, continuous inflation chamber. A single inflation chamber can be folded in a serpentine arrangement, or can be one bladder structure with no internal walls or segregation point. The inflatable chambers can be arranged to provide uniform support across all areas of the patient transporter, or to provide customized levels of support in different zones.

FIG. 2B is another exemplary embodiment of patient transporter 10, where lower substrate 30 has an exterior cover 86 connected to upper substrate 20 to form a pocket that encloses inflatable chambers 80. The inflatable chambers may form a separate, lower substrate that is joined to an upper substrate on which a patient is transported, or may be integral to the upper substrate. The lower substrate may have an exterior cover that is connected to the upper substrate to form a pocket to completely enclose the inflation chambers, or the inflation chambers may be an external portion of the overall structure of the patient transporter. Exterior cover 86 protects inflatable chambers 80 from tears or punctures, and provides a finished appearance to patient transporter 10. Exterior cover 86 can be a constraint to expansion of inflatable chambers 80 for additional support to patient transporter 10. Lower substrate 30 can be connected to upper substrate 20 at seal points 27 by RF, heat wedge, adhesive, and/or ultrasonic technologies. In an alternative embodiment, inflatable chamber 80 is not directly connected to upper substrate 20 where exterior cover 86 forms pocket 88 to enclose inflatable chamber 80. This structure can be used when inflatable chambers 80 cover the majority of pocket 88, extend edge-to-edge when inflated, and do not shift when not inflated.

The quantity, size, and configuration of the inflatable chambers, as well as the properties of the material used for their manufacture, can be selected to regulate the degree of support, height, and buoyancy of the patient transporter, as well as the speed at which the inflatable chambers can be inflated.

Inflatable chambers 80 have a fill valve 84. Fill valve 84 is a port of entry for compressed or pressurized gas, typically air, N₂, O₂ or CO₂. Nitrogen and carbon dioxide are inert gases, and relatively inexpensive. Fill valve 84 can be a single valve for inflation of all inflatable chambers 80 through a common fill line (as shown); alternatively, each inflatable chamber 80 can have its own fill valve 84.

Absorbent body 24 is connected to a first (top) side of backing substrate 22, and is made of an absorbent material that can absorb a large amount of body fluids from the patient being carried. Absorbent body 24 is typically sized less than backing substrate 22 (as shown in FIG. 2A or 2B or both), so that a portion of the backing substrate forms an edge about a portion of absorbent body 24. Absorbent body 24 can be permanently connected to backing substrate 22, or can be a separate piece that is removably connected to backing substrate 22, thereby permitting absorbent body 24 to be removed after use and replaced with an unused absorbent body 24. Absorbent body 24 can be removably connected to backing substrate 22 by an adhesive material, either on the absorbent body or on the backing substrate, where the adhesive material includes, but is not limited to, glue, two-sided tape, thread, and/or a hook-and-loop interlocking device such as VELCRO®.

An example of upper substrate 20 that can be used with the patient transporter 10 of the present disclosure include the disposable transporter disclosed in U.S. patent application Ser. No. 12/449,706 (“Disposable Transporter”), and the lightweight transporter with anti-hypothermia structures disclosed in PCT Application No. PCT/US2008/076293 (“Lightweight Absorbent Transporter”), both of which are incorporated herein by reference.

An example of head cover 52 that can be used with the present disclosure is disclosed in PCT Application No. PCT/US2009/031007 (“Absorbent Head Cover”), the contents of which are incorporated herein by reference.

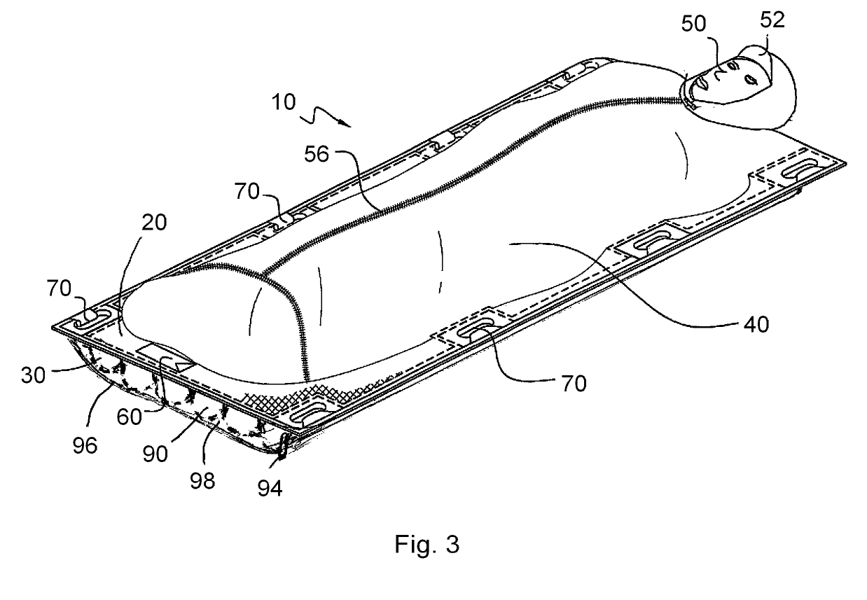

FIG. 3 is another exemplary embodiment of patient transporter 10 having an upper substrate 20 and a lower substrate 30 having one or more inflatable chambers 90 in a vertical configuration; i.e., oriented in the same direction as a patient 50 carried on patient transporter 10. Lower substrate 30 has inflatable chambers 90 in a vertical configuration that extends from a widthwise edge to the opposite widthwise edge of patient transporter 10. Fill valve 94 is a valve to inflate inflatable chambers 90. Fill valve 94 can be a single valve for inflation of all inflatable chambers 90 (as shown). Alternatively, each inflatable chamber 90 can have its own fill valve 94. The inflatable chambers can have a single fill valve with a common fill line to inflate all chambers at the same time, or each inflatable chamber can have a fill valve. Upper substrate 20 has one or more top covers 40 (which cover patient 50), closure 56, head cover 52, pocket 60, and gripping devices 70 around the edges of patient transporter 10. Lower substrate 30 may optionally have an exterior cover 96 connected to upper substrate 20, to form a pocket 98 that encloses inflatable chambers 90. Exterior cover 96 protects inflatable chambers 90 from tears or punctures, and provides a finished appearance to patient transporter 10. Exterior cover 96 can also function as a constraint to expansion of inflatable chambers 90, to provide additional support and firmness to patient transporter 10. In embodiments where exterior cover 96 forms pocket 98, inflatable chambers 90 do not need to be directly connected to upper substrate 20, particularly when inflatable chambers 90 cover the majority of pocket 98, extend edge-to-edge when inflated, and do not shift when not inflated.

The number, size, and configuration of inflatable chambers 80, 90 in lower substrate 30, as well as the thickness and elasticity of the material used for their manufacture will affect the level of support, height, and buoyancy that lower substrate 30 provides to patient transporter 10. The number, size, thickness, and elasticity of inflatable chambers 80, 90 also affect the speed at which inflatable chambers 80, 90 can be inflated to provide support for patient transport.

A benefit of using inflatable chambers 80, 90 to provide support to patient transporter 10 is that the user can regulate the pressure in order to obtain a desired balance of rigidity and flexibility of patient transporter 10. In a preferred embodiment, inflatable chambers 80, 90 are inflated until patient transporter 10 is semi-rigid, yet retains sufficient flexibility to provide a small deflection value that is about three inches (3″) (7.6 cm) to about five inches (5″) (12.7 cm) from horizontal when a patient is carried thereon. As used herein, “deflection value” means the downward distance that patient transporter 10 bends when a patient is being transported thereon as compared with a perfectly horizontal line. The deflection value for patient transporter 10 significantly enhances patient comfort during transport (and makes patient transporter 10 easier for the litter carriers to carry for long distances) as compared with conventional litters, while maintaining the strength and overall firmness of the patient transporter. For more precise regulation of gas pressure, and to compensate for variations due to altitude, as when patient transporter 10 is used in mountainous terrain or at sea level, a gas pressure regulator (not shown) can be used.

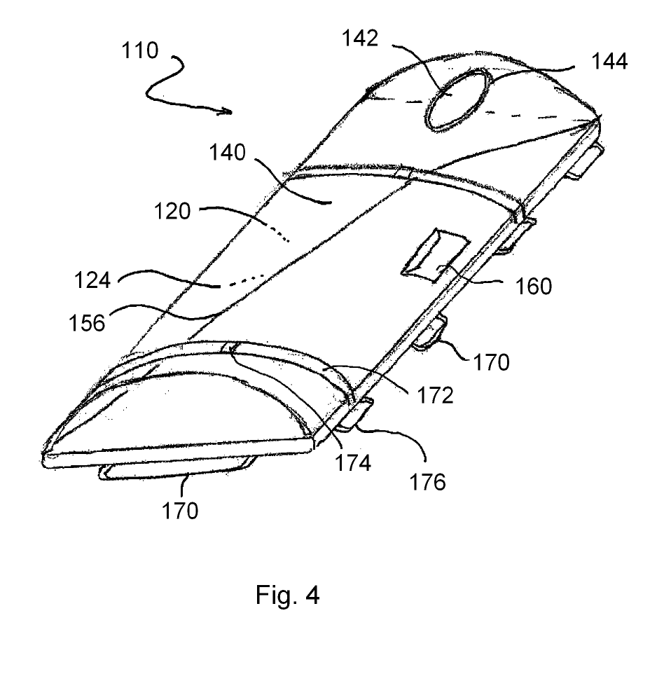

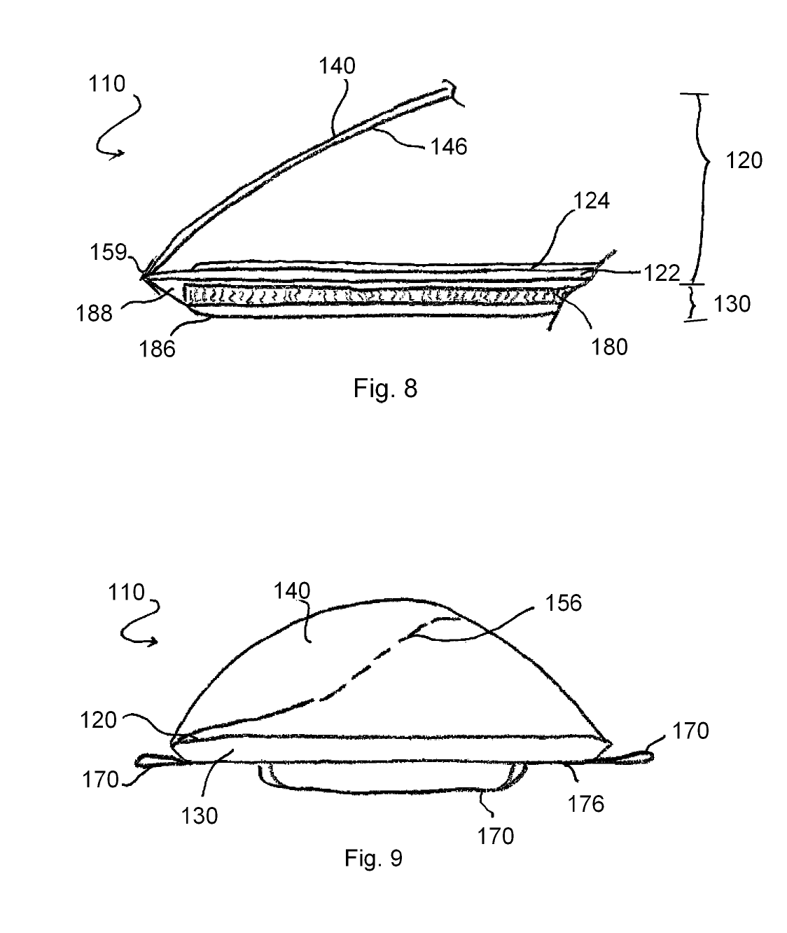

Referring to FIG. 4, patient transporter 110 has an upper substrate 120 and a lower substrate 130 that is connected to a bottom side of upper substrate 120. Upper substrate 120 has a top side and a bottom side. The top side of upper substrate 120 includes a top cover 140 that can be opened and closed by a closure device 156. The bottom side of upper substrate 120 is formed by a backing substrate 122 (also shown in FIG. 8).

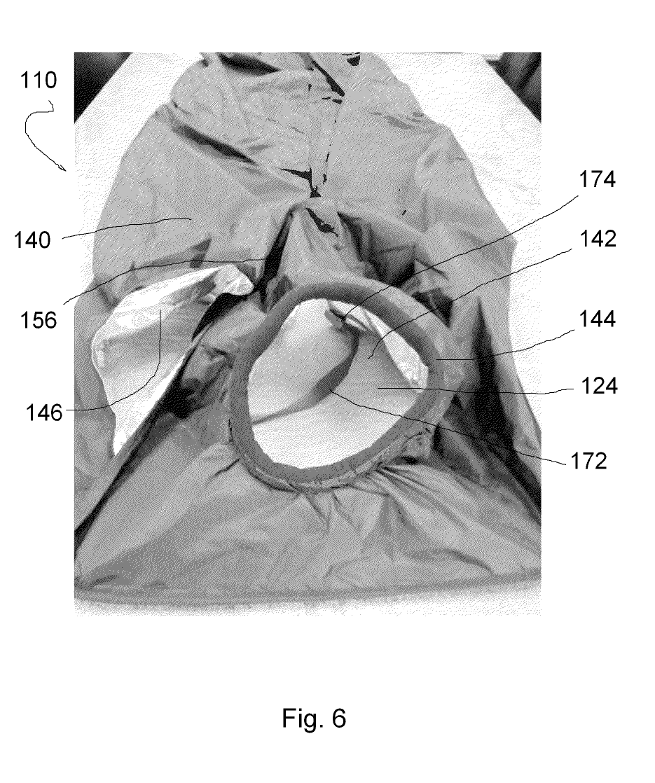

Upper substrate 120 can include an absorbent body 124 disposed on a top surface of backing substrate 122 (also shown in FIGS. 6 and 8). Top cover 140 and/or upper substrate 120 can have a pocket 160 for holding medical paperwork, identification information, medications, clothing, and the patient's personal items.

Top cover 140 has a cut-out opening 142 to fit around a patient's face and head during transport, so that a part or all of the patient's face and head are exposed while the patient's body is otherwise partially or completely covered by top cover 140. Cut-out opening 142 also be called a face portal, facial hole, face sock, face pocket, and face collar with no change in meaning. Cut-out opening 142 can have a padded collar 144 around the perimeter of cut-out opening 142 to provide a snug, cushioned fit of cut-out opening 142 around the patient's face and head. Top cover 140 may also have a thermal liner and/or a reflective interior surface to further reduce the risk of hypothermia.

In an alternative embodiment (not shown), closures 156 for top cover 140 can be left open so that the patient's face remains exposed during transport, so that there is no need for cut-out opening 142 in top cover 140.

Cut-out opening 142 and/or collar 144 can have a drawstring (not shown) that can be pulled or loosened to provide a customized fit of cut-out opening 142 and/or collar 144 snugly around the patient's face and head.

Top cover 140 can have one or more closures 156 that allow access to the interior of patient transporter 110. Closures 156 include, but are not limited to, one or more zipper, hook, snap, adhesive tape, buttons, hook-and-loop fasteners (e.g., VELCRO®), rib-and-groove seals, or any combinations thereof. As shown in FIG. 4, closure 156 is a zipper arranged in a curved configuration extending from one widthwise edge of patient transporter 110 to the opposite widthwise edge. Another exemplary embodiment of top cover 140 has closure 156 configured in an “R-curve” design that can be quickly opened and closed and provides wide access to the interior of patient transporter 110.

One or more gripping devices 170 are positioned about the outer edges of patient transporter 110 to provide an easy handhold for the carrier. In one embodiment, gripping devices 170 are formed along the edges of patient transporter 110 by loops of straps 176 that extend across the entire width (or entire length) of the bottom surface of patient transporter 110, and extend beyond the edges.

One or more securing straps 172 having buckles 174 or other devices to regulate tension can be connected to patient transporter 110 over top cover 140 (as shown in FIG. 4) to further secure the patient during transport.

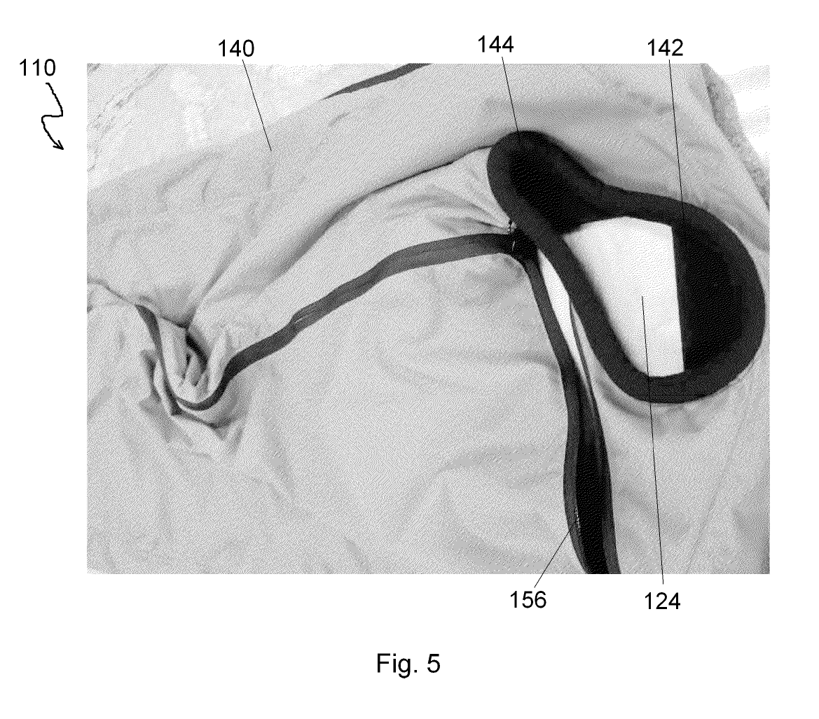

Referring to FIG. 5, top cover 140 has cut-out opening 142 that fits about the patient's face and head, and has a padded collar 144 around the perimeter. Top cover 140 can be sewn so that cut-out opening 142 and collar 144 are shaped to slope upward to conform more comfortably around the natural shape of the patient's neck and lower jaw. Absorbent body 124 is disposed on upper substrate 120 and is visible in FIG. 5 though cut-out opening 142. In this embodiment, closure device 156, shown here as a zipper, is configured in a “R-shape” to curve over to one lengthwise edge of patient transporter 110 so that the patient can be easily placed under top cover 140 before transport and easily removed from patient transporter 110 after transport.

Referring to the exemplary embodiment in FIG. 6, top cover 140 is made of a black nylon material. Closure 156 is partially open and a portion of the underside of top cover 140 is turned up in order to display thermal liner 146. In an exemplary embodiment, thermal liner 146 is a reflective polyester film, such as MYLAR®, which assists in retaining body heat and reduces the risk of hypothermia.

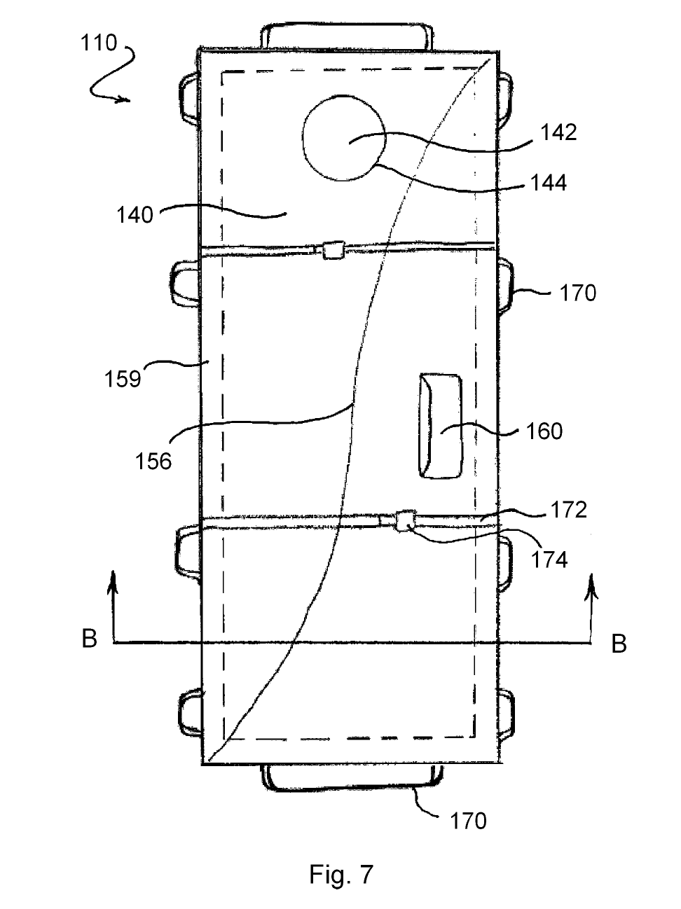

Collar 144 is made of a padded material and provides a comfortable, cushioned, snug fit of top cover 140 around the patient's face and head, further reducing loss of body heat and the risk of hypothermia. Since closures 156 are open in FIG. 6, a securing strap 172 and buckle 174 can be seen under top cover 140 through cut-out opening 142. Securing straps 172 and buckles 174 are typically disposed above top cover 140 (as in the embodiments in FIG. 4 and FIG. 7), but can be underneath top cover 140 as well.

Similar to absorbent body 24, absorbent body 124 is connected to the top surface of upper substrate 120 to absorb large amounts of body fluids, such as blood or urine, that may be exuded from the patient. Thus, absorbent body 124 keeps the patient dry and comfortable during transport, and reduces the risk of contamination to litter carriers and medical personnel. In an exemplary embodiment of absorbent body 124, the “large amount” of body fluids that can be absorbed is about four-and-a-half liters (4.5 L) of liquid. Absorbency of body fluids or other liquids by absorbent body 124 depends on the overall size and structure (e.g., numbers of layers and types of absorbent material used in each layer) of the absorbent body. Typically, absorbent body 124 absorbs about 1.70 to about 1.75 grams of body fluids liquids per square inch of absorbent material. Absorbency can further be adjusted to a higher or lower level simply by changing to a higher-performance or lower-performance absorbent material or structure.

Absorbent body 124 can have one or more layers of absorbent or superabsorbent material. The one or more layers can be adjacent to each other, bonded together, or formed into a composite structure. Examples of absorbent or superabsorbent material that can be used for absorbent body 124 include, but are not limited to, cellulose, cellulose fiber, fluff pulp, airlaid material, nonwoven, airlaid nonwoven, a superabsorbent polymer (SAP), SAP composite, thermoplastic polymer fibers, airlaid SAP, a fibrous or foam structure coated with SAP, starch-based superabsorbents, such as BIOSAP™ (Archer Daniels Midland, Decatur, Ill.), or any combinations thereof. The absorbent material may be treated or coated with a surfactant to regulate uptake and strikethough of fluids, or to direct absorption to another portion or zone of absorbent body 124 away from the patient.

Absorbent body 124 and/or patient transporter 110 may also contain one or more active agent (not shown). The active agent can be positioned anywhere on and/or in absorbent body 124 or patient transporter 110, to reduce infection and contamination by microbial pathogens, and to reduce and/or eliminate odors. The active agent is preferably positioned in and/or on absorbent body 124. The one or more active agent can include, but is not limited to, a bactericide, bacteriostatic agent, fungicide, virucide, disinfectant, sanitizer, sterilizer, mildewstat, surfactant, deodorizer, or any combinations thereof. Examples of active agents include, but are not limited to, a: metal, metal compound, surface active agent, quaternary ammonium compound, organic acid, inorganic acid, salt, sulfite, biopolymer, synthetic polymer, chitin, chitosan, nisin, enzyme, arginate, diacetate, antioxidant, or any combinations thereof. An active agent may be present at absorbent body 124 or transporter 110 in its active form, or present in an inactive form that becomes activated upon contact with other liquids, such as body fluids from the patient, or by external water or moisture.

Referring to FIG. 7, patient transporter 110 has top cover 140 that is connected to an upper substrate (not shown) and/or a lower substrate (not shown). A binding 159 is positioned about the perimeter of patient transporter 110 to provide additional strength and/or a finished appearance to the patient transporter. An example of binding 159 is a one inch (1″) nylon webbing material, which can be sewn around the outer perimeter of patient transporter 110. For reference, FIG. 7 also shows cut-out opening 142, collar 144, closure 156, pocket 160, gripping devices 170 positioned at the sides and ends of patient transporter 110, and securing straps 172 with buckles 174.

As shown in FIG. 8, upper substrate 120 has a top side and a bottom side, and includes a top cover 140, a backing substrate 122 that forms the bottom side of upper substrate 120, and an absorbent body 124 therebetween that is connected to backing substrate 122. Lower substrate 130 includes an exterior cover 186 that is connected to the bottom side of upper substrate 120 (i.e., backing substrate 122) to form pocket 188. Pocket 188 completely encloses one or more inflatable chambers 180. In the exemplary embodiment of FIG. 8, top cover 140 is a nylon cover having thermal liner 146 on the underside.

Top cover 140 protects the patient's body from inclement weather and conserves body heat to reduce the risk of hypothermia. The anti-hypothermia properties of top cover 140 can be enhanced by making the top cover from an insulating material, or layered to contain an insulating material therein. Top cover 140 can be made of, or contain, one or more layers of an insulating material. Examples of insulating materials include, but are not limited to, fleece, nylon, cotton, wool, pile, polyester, polytetrafluoroethylene (PTFE), hollow-core polyester fibers, nylon/polyester blends, polyethylene, polypropylene, or any combinations thereof. These include commercially-available products such as GORE-TEX®, THERMO-LITE®, and CAMBRELLE®.

Referring to FIG. 9, patient transporter 110 has top cover 140, closure 156, upper substrate 120, lower substrate 130 with exterior cover 186, and gripping devices 170 along the lengthwise and widthwise edges.

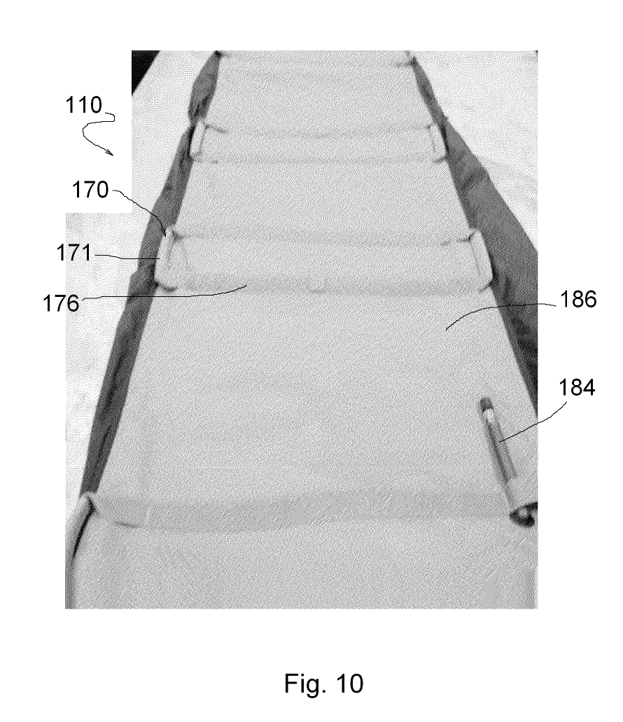

Referring to FIG. 10, one or more straps 176 are connected to the bottom side of exterior cover 186 and extend beyond the lengthwise edges of patient transporter, where straps 176 are looped to form gripping devices 170. Extra material 171 can be added to any of gripping devices 170 to provide a padded handhold for litter carriers, and to reinforce gripping devices 170. Fill valve 184, which passes through exterior cover 186, is connected to inflatable chambers 180 (not shown) for easy inflation.

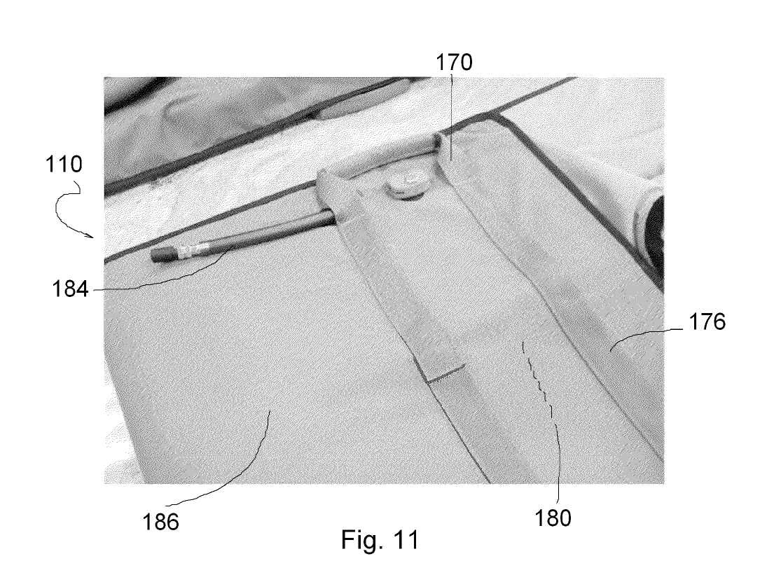

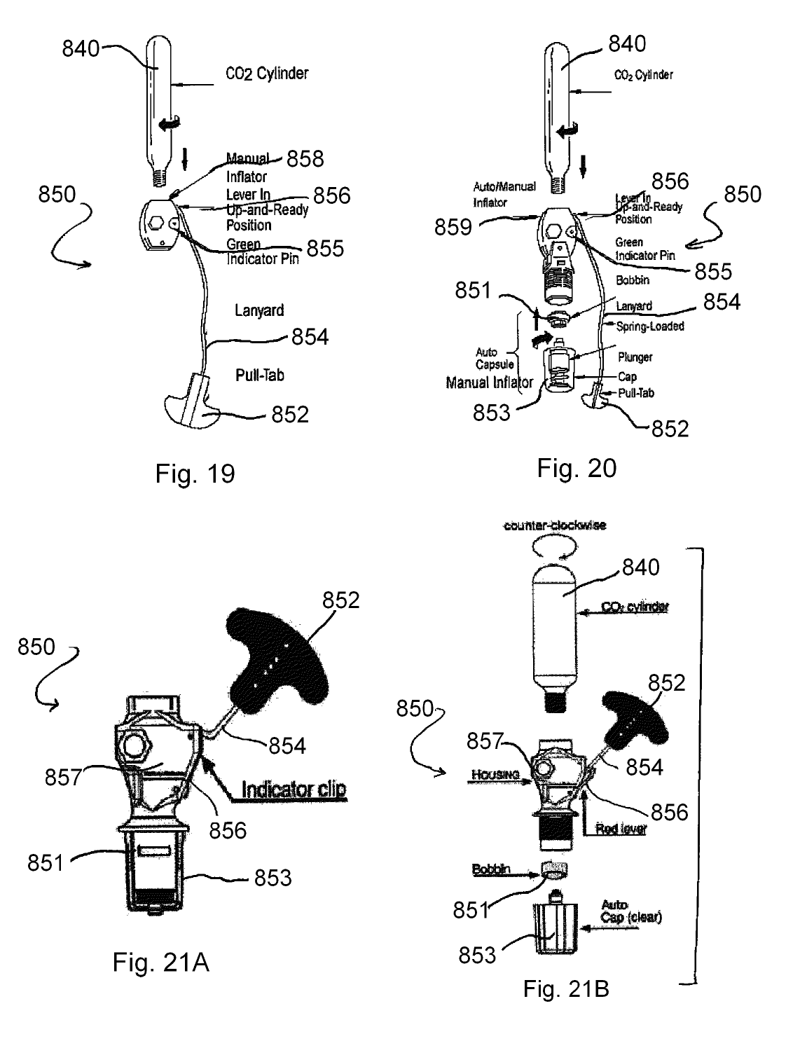

FIG. 11 shows details of fill valve 184, to which an air line, air hose, foot pump, gas canister (also called gas bottle or gas cylinder) can be connected to inflate inflatable chambers 180. A ripcord device with a pull-tab (as in FIG. 19, 20, 21A or 21B) can also be used to activate release of gas to inflate inflatable chambers 180 with a single action by the user.

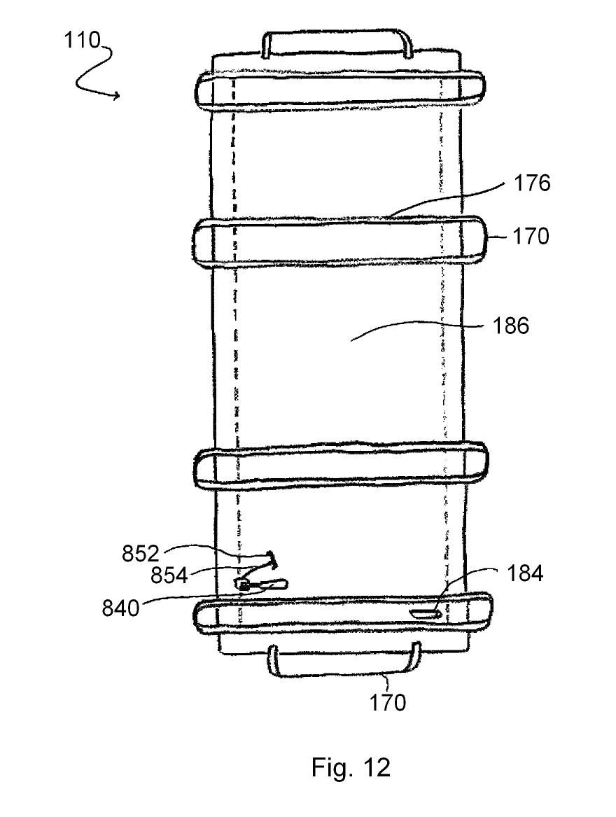

Referring to FIG. 12, gripping devices 170 are shown along both lengthwise edges, and are formed by loops of one or more straps 176 that are connected to exterior cover 186. Additional gripping devices 170 are connected to the widthwise edges (i.e., at the head and foot ends) of patient transporter 110. Fill valve 184 provides access to inflate the inflatable chambers (not shown). Gas canister 840 is also connected to the inflatable chambers and has a ripcord device (such as those shown in FIGS. 19, 20, and 21A/21B) that can be armed by the user to activate inflation by the gas with a single pull of pull-tab 852 and lanyard 854.

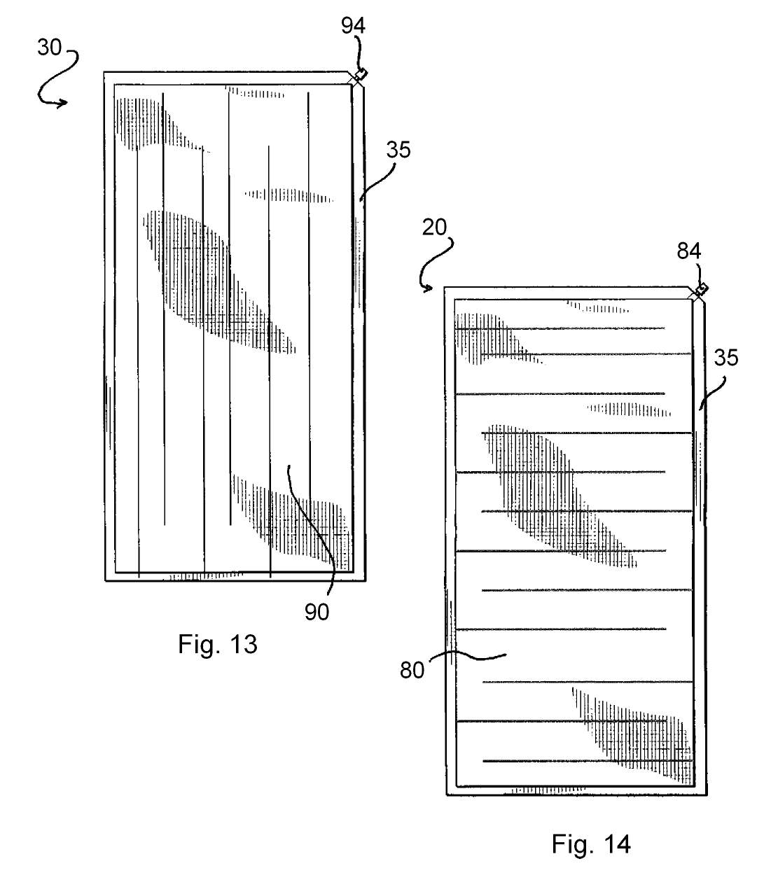

FIG. 13 is an exemplary embodiment of lower substrate 30, representing inflatable chamber 90 that is a single, continuous bladder in a serpentine arrangement. Inflatable chamber 90 is folded to have a vertical configuration when connected to the bottom side of upper substrate 20 in patient transporter 10, as represented in FIG. 3. Fill valve 94 is used to inflate inflatable chamber 90. Lower substrate 30 has an outer edge 35 that extends around the edges of inflatable chamber 90 to form a perimeter around lower substrate 30.

FIG. 14 is an exemplary embodiment of lower substrate 30, having inflatable chamber 80 that is a single, continuous bladder in a serpentine arrangement. Inflatable chamber 80 is folded to have a horizontal configuration when connected to the bottom side of upper substrate 20 in patient transporter 10, as represented in FIG. 1. Fill valve 84 is used to inflate inflatable chamber 80. Lower substrate 30 has an outer edge 35 that extends around the edges of inflatable chamber 80 to form a perimeter around lower substrate 30.

Another exemplary embodiment of lower substrate 30 (not shown) has a single inflatable chamber 80 with no internal walls or segregation points that form a serpentine configuration, where the single chamber provides support for all of patient transporter 10 when inflated.

Another embodiment of patient transporter 10 has at least one inflatable chamber 80 oriented vertically and at least one inflatable chamber 80 oriented horizontally. Another embodiment has at least one inflatable chamber 80 that is oriented in an oblique angle relative to the direction of patient 50. A preferred embodiment has inflatable chambers 80 in a horizontal orientation that form a bracing support for the patient 50 on patient transporter 10.

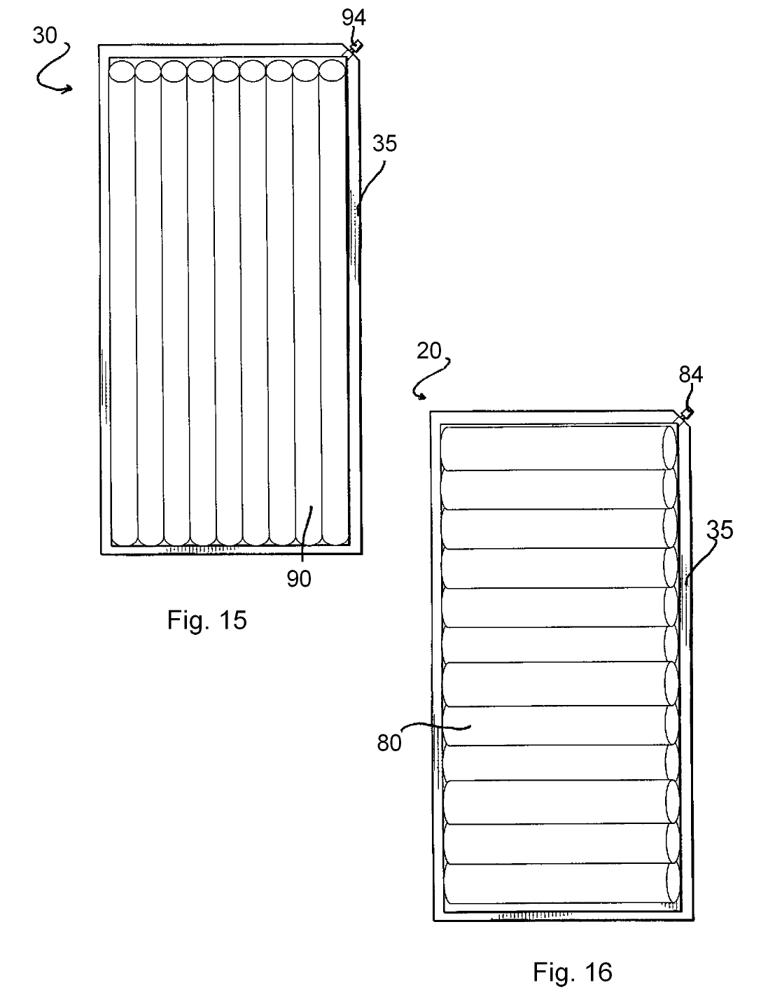

FIG. 15 is another exemplary embodiment of lower substrate 30, having inflatable chambers 90 that are a plurality of discrete bladders that are adjacent each other. Each inflatable chamber 90 is a separate air pocket. Inflatable chambers 90 are in a vertical configuration when connected to the bottom side of upper substrate 20 in patient transporter 10, as represented in FIG. 3. Fill valve 94 is used to inflate inflatable chambers 90. As shown in FIG. 15, a single fill valve 94 can be used to inflate all of inflatable chambers 90 through a common fill line. Alternatively, each of inflatable chambers 90 can have a fill valve 94. Lower substrate 30 has an outer edge 35 that extends around the edges of inflatable chambers 90 to form a perimeter around lower substrate 30.

FIG. 16 is another exemplary embodiment of lower substrate 30, having inflatable chambers 80 that are a plurality of discrete bladders that are adjacent each other. Each inflatable chamber 80 is a separate air pocket. Inflatable chambers 80 are in a horizontal configuration when connected to the bottom side of upper substrate 20 in patient transporter 10, as represented in FIG. 1. Fill valve 84 is used to inflate inflatable chambers 80. In the embodiment shown in FIG. 16, a single fill valve 84 can be used to inflate all of inflatable chambers 80 through a common fill line. Alternatively, each of inflatable chambers 80 can have a fill valve 84. Lower substrate 30 has an outer edge 35 extends around the edges of inflatable chambers 80 to form a perimeter around lower substrate 30.

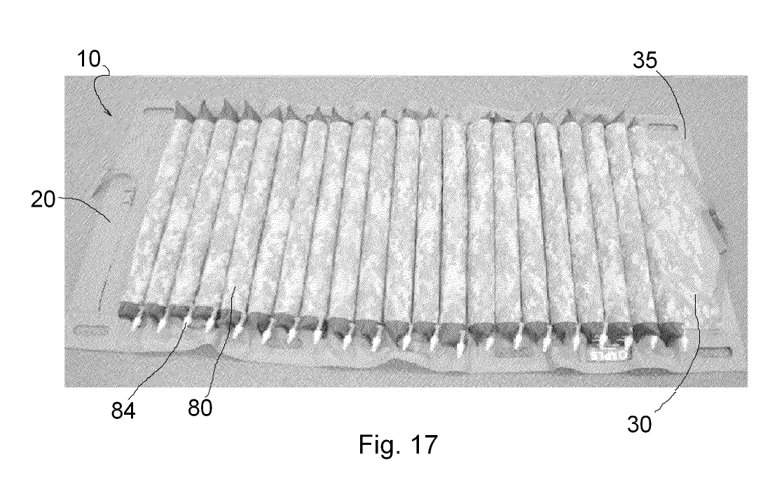

FIG. 17 is an exemplary embodiment of patient transporter 10 having lower substrate 30 connected to a bottom side of upper substrate 20. Lower substrate 30 has a plurality of discrete inflatable chambers 80 arranged in a horizontal configuration (as represented in FIG. 16). Each inflatable chamber 80 has a fill valve 84. Outer edge 35 (visible at the top edge) forms an outer edge of lower substrate 30 and is connected to the bottom side of upper substrate 20. Normally, outer edge 35 would be connected to the end of patient transporter 10, but is not connected in FIG. 17 to provide better visibility of inflatable chambers 80. In this embodiment, a camouflage nylon material is used as a cover material for inflatable chambers 80.

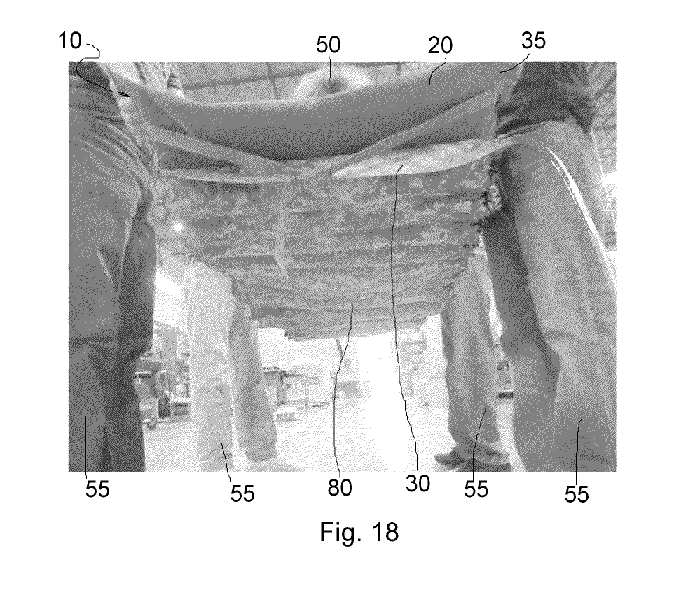

FIG. 18 is the exemplary embodiment of patient transporter 10 in FIG. 17 when raised by litter carriers 55 off the ground, as would be done when using patient transporter 10 to transport a patient 50. Patient transporter 10 has an upper substrate 20 and a lower substrate 30 connected to a bottom surface of upper substrate 20. Lower substrate has inflatable chambers 80 (shown inflated) arranged in a horizontal configuration, extending from one lengthwise edge to the opposite lengthwise edge of patient transporter 10. Lower substrate 30 has an outer edge 35 that is shown as partially connected to the bottom side of upper substrate 20 to provide better visibility of inflatable chambers 80. Litter carriers 55 are manually gripping and lifting patient transporter 10 via gripping devices 70, to lift patient 50 off the ground.

Inflatable chambers 80, 90 can be filled with air, or any other gas (including, but not limited to N₂, O₂, and CO₂). A filling device such as a gas canister, air tank, air hose, air pump, bottle of compressed gas, and foot pump can be attached to fill valve 84, 94 for inflation. Inflatable chambers 80, 90 can also be inflated by a person blowing air into fill valve 84, 94. Attaching a gas cartridge (not shown) to fill valve 84 can rapidly and fully inflate inflatable chambers 80, 90 in about 30 seconds or less. Optionally, for more rapid inflation, a gas canister can contain a pre-set amount of gas or liquid to provide the desired internal pressure to inflatable chambers 80, 90, so there is no need for the person in the field to pause while monitoring the amount of the gas used for full inflation. Alternatively, inflatable chambers 80, 90 can be filled with a lightweight liquid and/or solid, such as a foam or gel. The foam may be stored in liquid and/or gaseous form in the canister, and expand to a solid foam when filling inflatable chambers 80, 90. In another embodiment, liquid may be used that, upon contact with air (or a second component) forms a gas or foam which fills inflatable chambers 80, 90. Inflating (or filling) inflatable chambers 80, 90 provides rigidity and support to patient transporter 10.

A ripcord device 850 (also called ripcord valve without a change in meaning), can be employed as a switch (or trigger) to activate a gas canister filled with a pressurized gas for rapid inflation of the inflatable chambers of patient transporter 110. The pressurized gas can be, but is not limited to, air, CO₂, O₂, helium, or N₂, or any combinations thereof. Ripcord device 850 can be armed and activated manually by the user.

FIG. 19 is an exemplary embodiment of a ripcord device 850 and gas canister 840, with arrows indicating how the gas canister is connected to the ripcord device. Ripcord device 850 includes a pull-tab 852, lanyard 854 that connects pull-tab 852 to a lever 856, and inflator 858. To arm the ripcord device to inflate the pad, the user exposes inflator 858 and installs indicator pin 855 in inflator 858. Gas canister 840 is then screwed onto inflator 858, and ripcord device 850 armed and ready for use with a single pull of pull-tab 852.

FIG. 20 is another exemplary embodiment of ripcord device 850 having both automatic and manual firing capabilities. This embodiment of ripcord device 850 also includes pull-tab 852, lanyard 854 that connects pull-tab 852 to a lever 856, indicator pin 855, as well as an automatic/manual inflator 859. In this embodiment, ripcord device 850 also includes bobbin 851 and cap 853. To arm and operate this ripcord device 850, the user exposes the automatic/manual inflator 859, removes cap 853 and installs bobbin 851 into the base of automatic/manual inflator 859. The user then installs indicator pin 855 in lever 856. Gas canister 840 is then connected to ripcord device 850 as indicated by the arrows in FIG. 20, and ripcord device 850 is armed and ready for use.

FIG. 21A shows another exemplary embodiment of ripcord device 850 having an automatic firing capability. In this embodiment, ripcord device 850 has bobbin 851, pull-tab 852, cap 853, lanyard 854, lever 856, as well as a housing 857. Ripcord device 850 is armed and operated in the same manner as the embodiment in FIG. 20 above. FIG. 21B shows insertion of gas canister 840 into ripcord device 850, which has bobbin 851, pull-tab 852, cap 853, lanyard 854, lever 856, and housing 857.

Gas canister 840 and ripcord device can be entirely made of non-metals, or coated with non-metals, in order to reduce the risk of detection when the patient transporter is deployed in a hostile area. Examples of non-metallic materials that can be used for gas canister 840 include, but are not limited to, graphite-based, thermoplastic-based, or carbon fiber materials. An exemplary embodiment of non-metal gas canister 840 is made of fiberglass. For gas canisters made of thermoplastic-based materials, an inner coating of a gas-impervious material (not shown) can be added to improve retention of the pressurized gas. Alternatively, gas canister 840 can be made of a metal but dipped in a non-metallic coating, to reduce or prevent detection, and to function as an insulator, noise reducer, and/or a non-reflective surface that conceals the metal gas canister from detection.

The particular gas used for inflation of the patient transporters of the present disclosure can be selected based on the specific needs of the user. Oxygen gas (O₂) has the benefit of weighing slightly less than CO₂ for a given gas volume. Air weighs less per unit volume than O₂ or CO₂. CO₂ gas has the advantage of being generally non-combustible.

The patient transporters of the present disclosure can also include a rapid-deflation device (not shown) so that the inflation chambers can be quickly deflated after use for rapid disposal.

As used herein, “support” also means “rigidity” and “mechanical support.”

As used herein, “patient transporter” can be used interchangeably with “stretcher,” “litter,” and “transporter.” Likewise, “litter carriers,” “litter bearers,” and “stretcher carriers” can be used interchangeably.

The number, size, configuration, thickness, and elasticity of inflatable chambers 80, 90 can be selected in particular ratios to the outer dimensions of patient transporter 10 to provide desired levels of rigidity, and mechanical support. The greater the number and size of inflatable chambers 80, 90, the greater the support, height, and buoyancy provided to patient transporter 10. However, adding too many inflatable chambers 80, 90 represents excess weight and costs of patient transporter 10, and so the ratio between inflatable chambers 80, 90 to outer dimensions of patient transporter 10 should be balanced depending on the needs of the user.

In addition, the pressure of inflation or filling of inflatable chambers 80, 90 can be adjusted to provide the desired degree of support, height and/or buoyancy of patient transporter 10.

FIGS. 22 through 25 are examples of some materials and constructions that can be used to manufacture inflatable chambers 80, 90. As described below, the materials and fabrication method can be selected to impart a greater or lesser degree of flexibility and expansion to inflatable chambers 80, 90. Inflatable chambers 80, 90 can be manufactured independently of the upper substrate, and then joined to upper substrate 20 by RF (radio frequency) welding, or similar technologies, at seal points 27.

The examples of materials in FIGS. 22 through 25 are shown with edges open, in order to reveal the interior. However, when used to make inflatable chambers 80, 90, the materials would have a sealed, leakproof edge seal (not shown) that is formed by placing radio frequency (RF) weldable tape, gluing the edges, and thermal sealing of the edge material (top to bottom), thereby creating an air cavity inside that can be inflated to form inflatable chambers 80, 90. The material selected for inflatable chambers 80, 90 must allow for welding by high frequency, and must also be coated with a material that provides airtightness. FIGS. 10 through 13 are examples of double-walled materials that can be used for this purpose. Materials including, but not limited to, rubber, polyvinyl chloride (PVC), PVC/TPU, polyethylene, polypropylene, treated urethane-based textiles, nylon with urethane treatment, perfluoroplastic material, or any combinations thereof, can be used to make inflatable chambers 80, 90. The material is preferably tear-resistant and puncture-resistant.

FIG. 22 is a section of polyvinyl chloride (PVC)-coated material 290 that can be used to manufacture inflatable chambers 80, 90. The PVC-coated material is double-walled and flexible. FIG. 23 is a polyvinyl chloride/thermoplastic polyurethane (PVC/TPU)-coated material 292 having an additional top layer that can also be used to manufacture inflatable chambers 80, 90. PVC/TPU-coated material 292 is a more rigid structure and less flexible than the PVC-coated material 290.

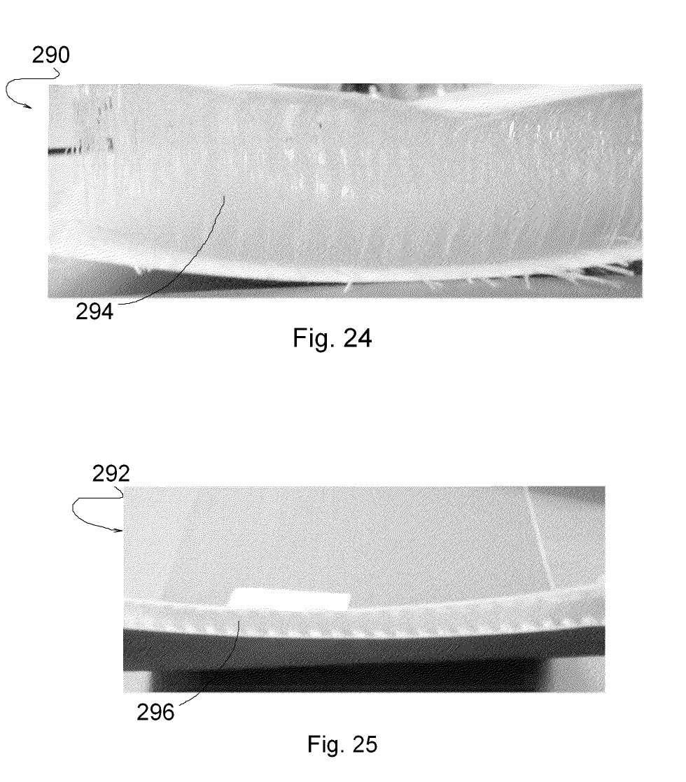

FIG. 24 represents the structural effects of introducing air into PVC-coated material 290 having a sealed, leakproof edge seal. The PVC-coated material inflates only to the height that the attachment fibers 294 allow. Attachment fibers 294 can be nylon, or similar material.

Similarly, FIG. 25 represents the structural effects of introducing air into PVC/TPU-coated material 292 having a sealed, leakproof edge seal. The PVC/TPU-coated material 292 only inflates to the height that attachment fibers 296 allow.

The length of internal attachment fibers 294, 296, can be selected to regulate the height of inflatable chambers 80, 90. For example, using long internal attachment fibers 294 creates more room for inflation and a higher profile to inflatable chambers 80, 90, thereby providing a greater height above the ground or water surface of upper substrate 20 (and any absorbent body 24) on which a patient is resting. By contrast, using a material having short internal attachment fibers 296 provides a thin profile to the overall inflated patient transporter 10.

In this way, the selection of material, internal attachment fibers, and method of structural fabrication can be used to impart a greater or lesser degree of flexibility, expansion, and/or height to inflatable chambers 80, 90, and to the overall profile of patient transporter 10.

In situations where patient transporter 10 is being pulled or dragged across a wet surface, such as snow-covered ground or saturated (marshy) ground, inflatable chambers 80, 90 provide buoyancy and height over the wet ground, to help keep the patient dry and comfortable, and reducing contamination of the patient by the wet ground. The height above the ground also keeps the upper substrate 20 dry, thereby helping to maintain the strength and integrity of the upper substrate.

The buoyancy provided by inflatable chambers 80, 90 permit patient transporter 10 to float, depending on the degree of buoyancy provided by the inflatable chambers, and weight of the patient. An inflatable border of material (not shown) can be added around the perimeter of patient transporter 10 to protect and comfort the patient, and to prevent soaking by exterior water of absorbent material in absorbent body 24 on upper substrate 20.

A patient transporter of the present disclosure is less than 10 pounds (4.5 kg) in total weight, and it is preferably less than 7 pounds (3.2 kg) in total weight, and more preferably is about 5 pounds (2.3 kg) or less in total weight (which is considerably less than conventional rigid litters, which are typically eighteen pounds (18 lbs.) (8.2 kg) to nineteen pounds (19 lbs.) (8.6 kg), and especially conventional litters having antihypothermia covers), thereby enhancing ease of portability when carrying the transporter to the site, and when transporting a patient.

An exemplary embodiment of patient transporter 10 has little or no metal, other than buckles and zippers, and preferably contains no metal to avoid detection by a combatant on a battlefield.

Patient transporter 10 is disposable after use. Alternatively, patient transporter 10 can be re-used, for example, if the used absorbent body 24 is removed and replaced. For ease of disposability, an embodiment of absorbent body 24 can be made of a biodegradable and/or compostable absorbent material, such as a starch-based absorbent or starch-based superabsorbent material, including, but not limited to, BioSAP™ (Archer-Daniels Midland, Decatur, Ill.).

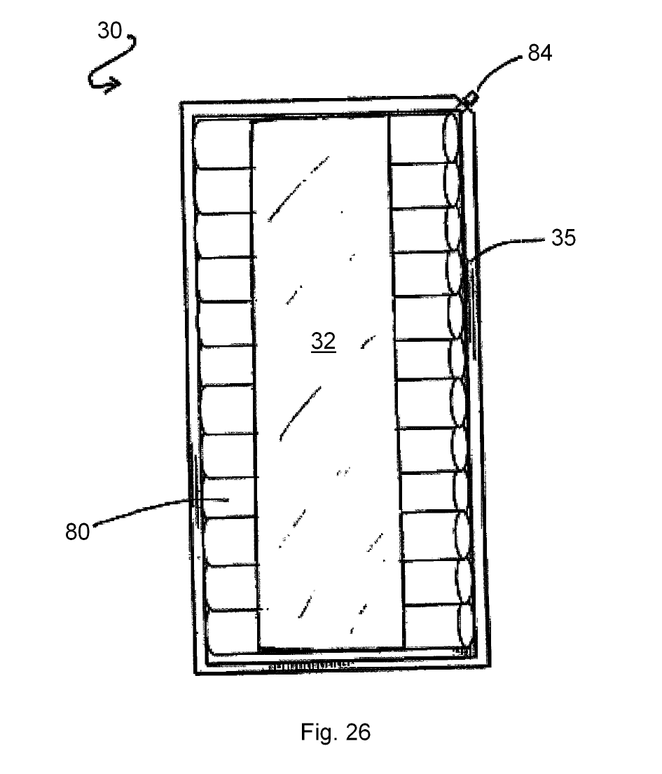

FIG. 26 provides an embodiment of patient transporter 10 of the present disclosure having a smooth material segment called a skid plate 32 (also called a “skid pad” or “material segment” in this application interchangeably) that is connected to an outer surface of lower substrate 30. Skid plate 32 can be connected to the bottom side of the patient transporter of the present disclosure, to provide a smooth surface over which the patient transporter can be pulled or dragged across snow, sand, or rough terrain. Skid plate 32 provides a smooth outer surface that makes it easier for an individual carrier to pull or drag patient transporter 10 across land, water, snow, and/or sand when carrying a patient thereon. For example, the skid plate permits patient transporter 10 to be pulled behind a skier over snow-covered surfaces. Skid plate 32 can cover a part, or all, of the bottom (i.e., outer) surface of lower substrate 30. In a preferred embodiment, skid plate 32 extends in a longitudinal direction across the entire length of patient transporter 10 (i.e., from one widthwise edge to the opposite widthwise edge), to provide a solid, smooth planar surface between the ground and inflation chambers 80, 90 on the underside of patient transporter 10. Skid plate 32 can be connected to inflatable chambers 80, 90, and/or to outer edge 35, of lower substrate 30, or to the outer edge of patient transporter 10.

Skid plate 32 is made of any solid material having a smooth surface that is strong and tear-resistant, including, but not limited to, polyvinyl chloride (PVC). In an exemplary embodiment, skid plate 32 is about ten inches (10″) (25.4 cm) to about eighteen inches (18″) (45.7 cm) in width, and is the same length to extend the entire lengthwise outer dimension of lower substrate 30 or of patient transporter 10. In a preferred embodiment, skid plate 32 is about twelve inches (12″) (30.5 cm) to about fifteen inches (15″) (38.1 cm) in width. Skid plate 32 is sized to provide a large sliding plane without significantly interfering with the inflation of inflatable chambers 80, 90; for example, for skid plate 32 to have a bit of slack when connected to inflatable chambers 80, 90 in an uninflated condition, to permit room for expansion of inflatable chambers 80, 90 when inflated.

In an exemplary embodiment, skid plate 32 is disposed on a center portion of lower substrate 30, since the patient's body 50 (and the patient's center of gravity) tend to collect toward the center axis of patient transporter 10.

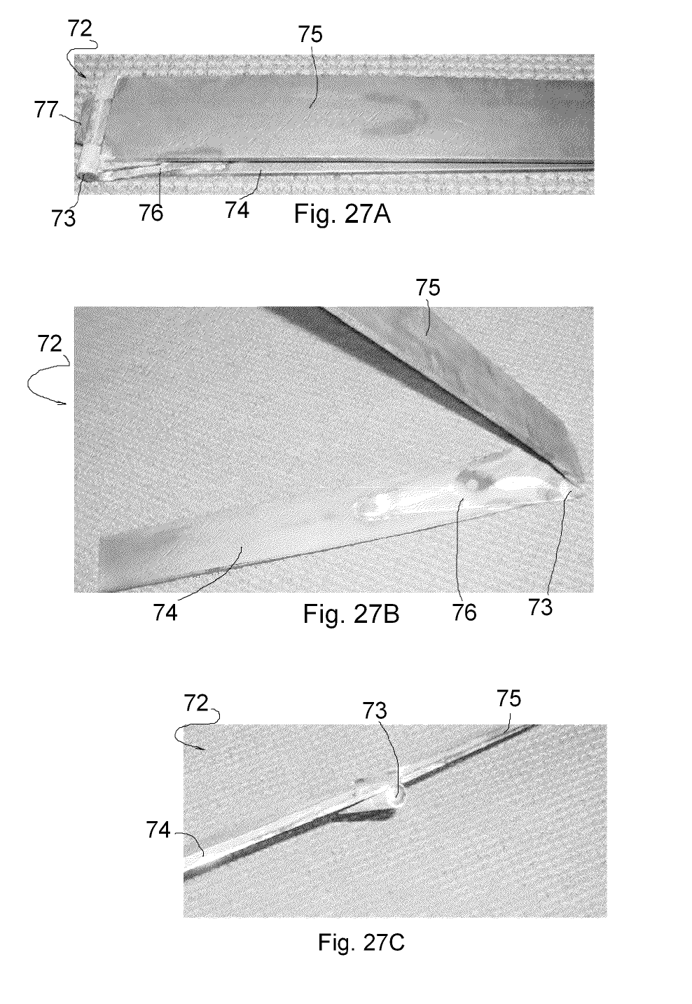

Patient transporter 10 can have a hinged support assembly 72 to provide additional rigidity and support under the person being carried. An exemplary embodiment of hinged support assembly 72 is shown in FIGS. 27A to 27C in its closed, partially-open, and fully-open positions, respectively. Hinged support assembly 72 has a hinge 73 that connects two or more solid segments 74, 75. Hinge 73 is connected to each of solid segments 74, 75 by a bracket 76. In a preferred embodiment, hinge 73 is able to open from a hinge angle of about 0° (closed) to about 180° (fully open and flat), including all hinge angles therebetween. Hinge 73 may have a hinge stop 77 that controls how far hinge 73 (and thus hinged support assembly 72) is able to open. In a preferred embodiment, hinge 73 is made to only close on itself in one direction. When hinge 73 is opened, hinge stop 77 only allows hinge 73 to open to form a straight segment from solid segments 74, 75. In a preferred embodiment, hinge 73 is oriented to the underside of patient transporter 10 (i.e., away from the person being carried), and hinge stop 77 is oriented towards the person above, so that the weight of the person, the inflated inflation chambers, and gravity act against hinge 73 so that hinged support assembly 72 becomes more rigid due to hinge stop 77 preventing an increase of the hinge angle beyond 180°.

Solid segments 74, 75 are made of a solid material having high tensile strength and light weight, including, but not limited to, metal, wood, molded plastic, resins, thermoset plastics, polyvinylchloride, high-density polyethylene, and polypropylene. As shown in FIGS. 27A to 27C, a preferred shape for solid segments 74, 75 is rectangular; however, each of solid segments 74, 75 can be shaped to reduce weight, increase strength, and/or enhance patient support and comfort when carried on patient transporter 10. For instance, in another exemplary embodiment (not shown), solid segment 74 may be curved and have a hollowed out portion to maintain strength and enhancing patient comfort when carried on the transporter. As shown in the exemplary embodiments in FIGS. 27A to 27C, solid segments 74, 75 are of approximately equal length and shape; however, solid segments 74, 75 can be of different lengths and shapes selected to provide the most rigidity and support to the transporter, as well as comfort to a person carried thereon.

As shown in FIG. 27A, hinged support assembly 72 is folded in half in a closed condition (hinge angle of about 0°), which is a preferred configuration for storage and carrying the hinged support device to a battlefield or other rescue site prior to integrating hinged support device 72 in patient transporter 10. FIG. 27B illustrates hinged support assembly 72 in a partially-opened condition (hinge angle of about 60°). FIG. 27C illustrates hinged support assembly 72 in its fully-open position (hinge angle about 180°), which is a preferred configuration when integrated in patient transporter 10, to reduce deflection in the center of the transporter under the maximum load area (center of gravity) of the person being carried on the transporter.

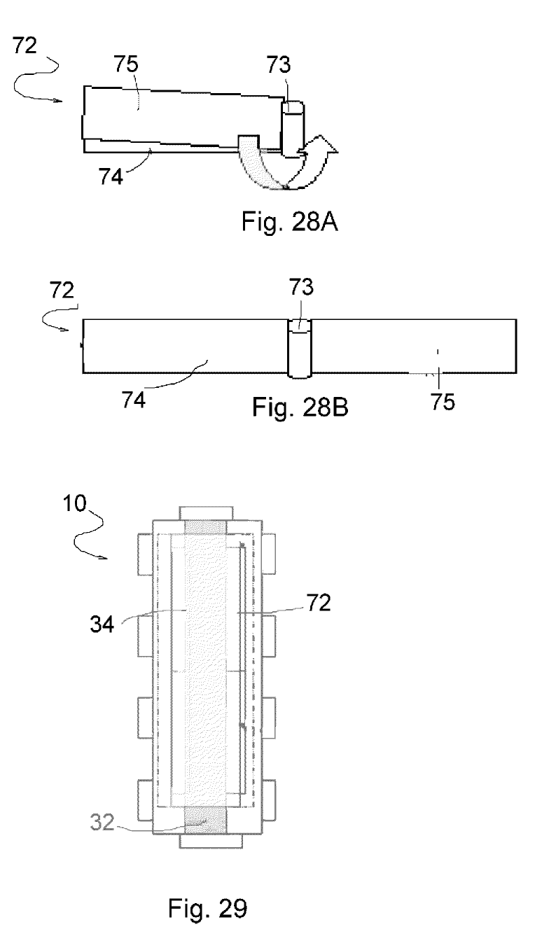

FIGS. 28A and 28B illustrate a hinged support assembly 72 being opened in the direction of the arrow by separating solid segments 74, 75 to move from a hinge angle of about 0° (closed) to a hinge angle of about 180° (open). FIG. 29 illustrates how hinged support assembly 72 is positioned on the bottom of patient transporter 10. In an exemplary embodiment, hinged support assembly 72 is placed on the bottom side of skid plate 32. In another exemplary embodiment, hinged support assembly is disposed on the underside of patient transporter 10 between skid plate 32 and a second, separate skid plate 34.

Hinged support assembly 72 can be connected to the lower substrate of patient transporter 10 by any connecting means, including, but not limited to, sliding solid segments 74, 75 and/or hinge 73 into pre-formed flaps (not shown) or holes (not shown) on the underside of the transporter, or removably attached to the underside of patient transporter 10, for example, by a hook-and-loop interlocking device such as VELCRO® (not shown).

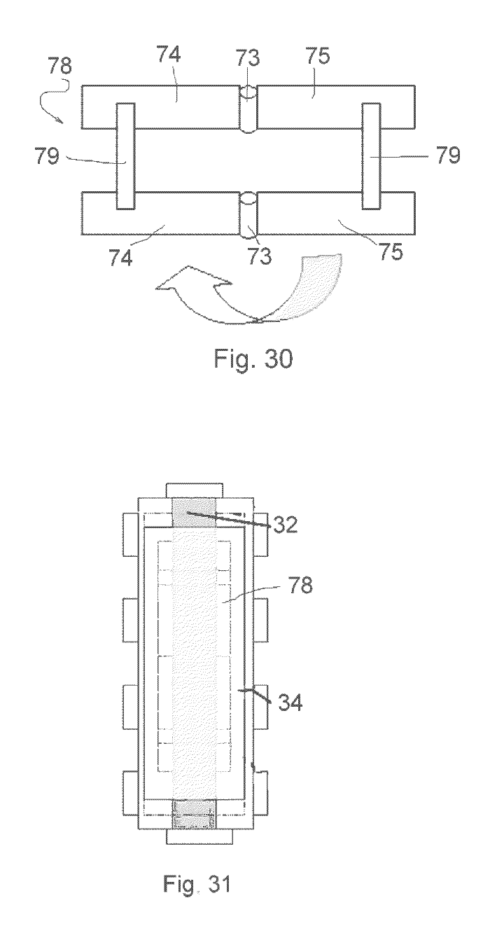

Two or more hinged support assemblies may be linked together to form a dual hinged support assembly 78. FIG. 30 shows an exemplary embodiment where dual hinged support assembly 78 is formed by two hinged support assemblies 72 positioned parallel to each other, with cross-segments 79 that connect one solid segment 74, 75 of the first hinged support device with the corresponding solid segment 74, 75 of the second hinged support device. Like an individual hinged support assembly 72, dual hinged support assembly 78 is able to fold over on itself to a hinge angle of 0° (closed for storage) and to open to a maximum hinge angle of about 180° (fully open and flat), as well as open to any hinge angle therebetween. Dual hinged support assembly 78 has the benefits of minimizing “rolling” effects when a person is carried on the transporter, and of enhancing stability of the transporter.

FIG. 31 illustrates how dual hinged support assembly 78 is positioned on the bottom of patient transporter 10. In an exemplary embodiment, dual hinged support assembly 78 is connected to the bottom side of skid plate 32 on the underside of patient transporter 10. In another exemplary embodiment, dual hinged support assembly 78 is disposed between skid plate 32 and a second, separate skid plate 34 on the underside of patient transporter 10.

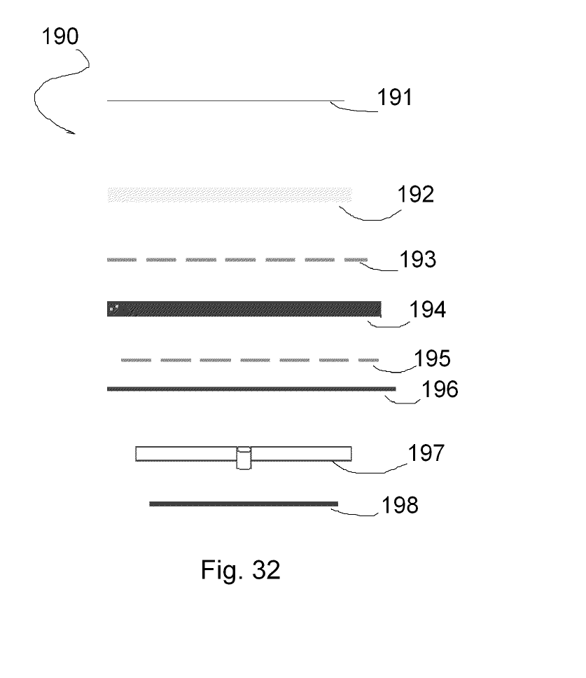

FIG. 32 illustrates a cross-section 190 of an exemplary embodiment of patient transporter 10 having a hinged support assembly 72 (or dual hinged support assembly 78) disposed between a first skid plate 32 and a second skid plate 34 on the underside of the transporter. Specifically, from top to bottom, cross-section 190 of the exemplary embodiment in FIG. 32 shows top cover 191, absorbent body 192, first textile layer (backing substrate) 193, inflatable chambers 194, second textile layer (exterior cover) 195, first skid plate 196, hinged support assembly 197, and second skid plate 198. Second skid plate 198 covers hinged support assembly 197, and is smaller than first skid plate 196. First skid plate 196 extends the full length of the transporter.

An exemplary embodiment of patient transporter 10 of the present disclosure has outer dimensions that are between about 20 inches (20″) (50.8 cm) to about forty-eight inches (48″) (121.9 cm) in width, by about sixty inches (60″) (152.4 cm) to about one-hundred-ten inches (110″) (279.4 cm) in length.

In a preferred embodiment, patient transporter 10 has outer dimensions of about thirty-three inches (33″) (83.8 cm) in width by about seventy-eight (78″) (198.1 cm) in length. Another preferred embodiment is about twenty inches (20″) (50.8 cm) in width by about seventy-two inches (72″) (182.9 cm) in length. A more preferred embodiment of patient transporter of the present disclosure has outer dimensions of about twenty-two inches (22″) (55.9 cm) in width by about seventy-six inches (76″) (193 cm) in length. A preferred embodiment of the inflatable chambers has outer dimensions of about sixteen inches (16″) (40.6 cm) in width by about seventy-two-and-one-half inches (72.5″) (184.2 cm) in length.

Patient transporter 10 is lightweight and portable. Prior to use, when inflatable chambers 80, 90 are uninflated, patient transporter 10 is easily rolled up or folded for ease of portability. In addition, inflating inflatable chambers 80, 90 provides excellent support without a significant increase in overall weight to the patient transporter.

Prior to use, patient transporter 10 can be rolled up tightly to fit in canisters or rucksacks that are carried by medics, soldiers, or emergency medical personnel including canisters that are about six inches (6″) (15.2 cm), about eight inches (8″) (20.3 cm), and all diameters therebetween.

Since patient transporter 10 has no rigid components when not inflated, patient transporter 10 can be collapsed and/or folded to a small size that is readily portable.

An alternative embodiment of patient transporter 10 is “half-sized” to carry children and small adults, having outer dimensions of about thirty-three inches (33″) (83.8 cm) in width (i.e., the same as for the full-size body bag) by about forty inches (40″) (101.6 cm) in length (i.e., about half of the length of a full-sized patient transporter 10).

An exemplary embodiment of patient transporter 10 of the present disclosure is able to support at least 300 lbs. (136.08 kg) of weight. Another exemplary embodiment of patient transporter 10 is able to support at least 350 lbs. (158.76 kg) of weight. Another exemplary embodiment of patient transporter 10 is able to support at least 400 lbs. (181.44 kg) of weight. A further exemplary embodiment of patient transporter 10 is able to support at least 450 lbs. (204.12 kg) of weight.

All of the dimensions, weights, and properties described above for patient transporter 10 also apply to patient transporter 110.

As used in this application, an inflatable chamber 80, 90 can be called a “bladder,” “inflatable bladder,” “inflation tube,” and/or an “air chamber” interchangeably.

Also, as used in this application, the word “patient” is used to mean any person who is carried on patient transporter 10, whether injured or ill, such as an injured soldier who is being carried from a battlefield.

As used in this disclosure, the word “about” for dimensions, weights, and other measures, means a range that is ±10% of the stated value, more preferably ±5% of the stated value, and most preferably ±1% of the stated value, including all subranges therebetween.

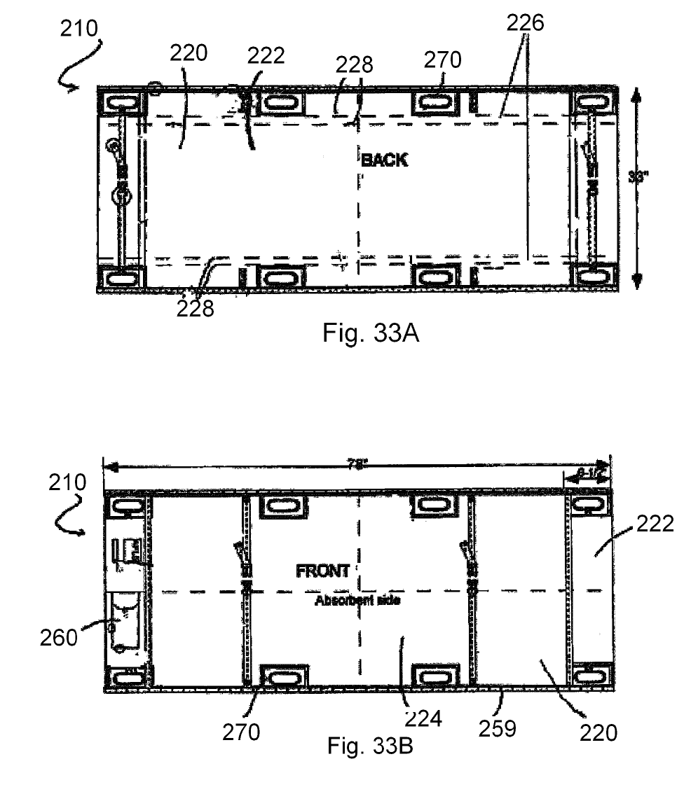

FIGS. 33A and 33B are the back and front sides, respectively, of an alternative embodiment of the patient transporter of the present disclosure, represented generally by reference numeral 210. Patient transporter 210 has an upper substrate 220. Upper substrate 220 has one or more channels 226 that are each formed by the space between two parallel seams 228 connecting an upper portion and a lower portion of upper substrate 220 (and so channels 226 are integral to upper substrate 220). In FIG. 33A, patient transporter 210 has two (2) channels 226 in a lengthwise (vertical) orientation in relation to patient transporter 210. In an alternative embodiment, the lengthwise channels 226 can be connected by one or more widthwise channels (not shown) in “H-shaped” or trellis configurations. Each of channels 226 can be made leakproof (air-tight), and can be RF welded to form pleats. Channels 226 are inflatable by any of the methods described herein. Alternatively, an inflatable bladder (not shown) can be positioned inside each channel 226. When inflated, channels 226 (like the inflatable chambers 80, 90 in other embodiments herein) provide improved rigidity, support, height, and some degree of buoyancy to patient transporter 210.

For orientation purposes, patient transporter 210 has gripping devices 270 around the perimeter of upper substrate 220, and a backing substrate 222 that forms the bottom (back) side of upper substrate 220. FIG. 33B shows absorbent body 224 disposed on the top (front) side of backing substrate 222. Absorbent body 224 is sized somewhat less than backing substrate 222, so that a portion of backing substrate 222 forms an edge about a portion of absorbent body 224. Pocket 260 is provided on the front side of patient transporter 210. A binding 259 is connected to each of the lengthwise edges to provide a finished appearance and strength to patient transporter 210.

In an alternative embodiment of patient transporter 210, one or more poles (not shown) can be passed through channels 226, to provide rigidity and support. The poles can be metal, wood, polymer, and/or plastic. The poles can extend beyond the outer edges of the transporter for litter carriers to manually lift and transport the patient. Alternatively, the poles can also be passed through two or more of gripping devices 270 to manually lift and transport the patient.

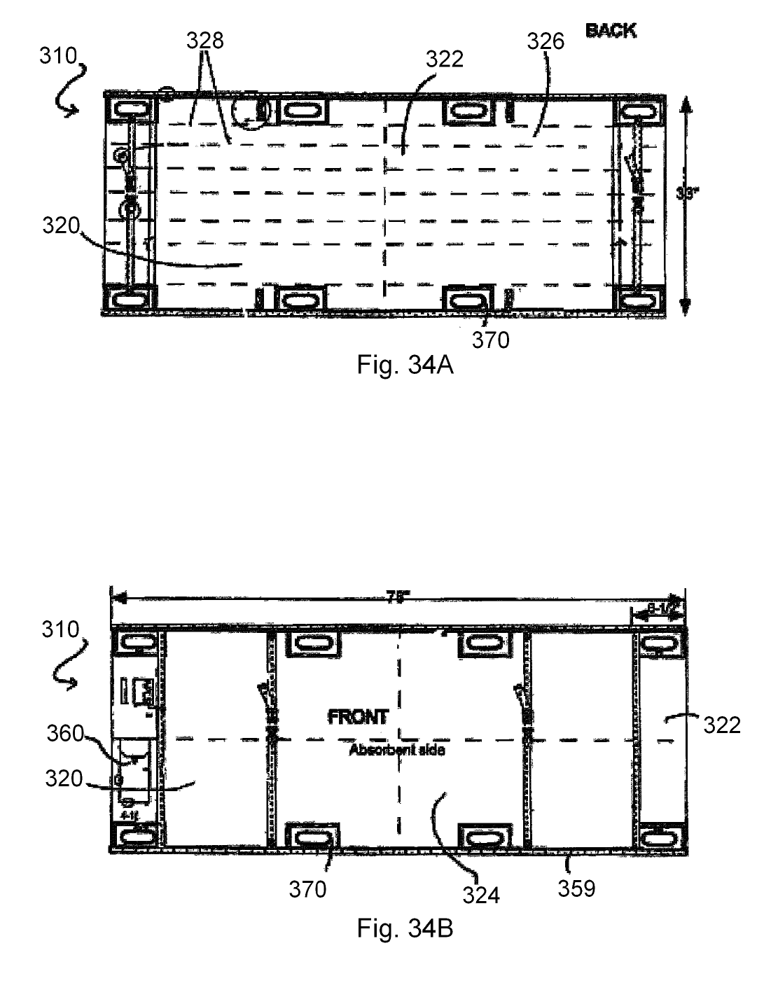

FIGS. 34A and 34B are the back and front sides, respectively, of another embodiment of a patient transporter of the present disclosure, represented generally by reference numeral 310. In this embodiment, patient transporter 310 has one or more channels 326 that are each formed by the space between two parallel seams 328 connecting an upper portion and a lower portion of upper substrate 320 (and so channels 326 are integral with upper substrate 320). In FIG. 34A, six (6) channels 326 in a lengthwise (vertical) orientation in relation to patient transporter 310 are shown. In an alternative embodiment, the lengthwise channels 326 can be connected by one or more widthwise channels (not shown) in “H-shaped” or trellis configurations. Each of channels 326 can be made leakproof (air-tight), and can be RF welded to form pleats. Channels 326 are inflatable by any of the methods described herein. Alternatively, an inflatable bladder (not shown) can be positioned inside each channel 326. When inflated, channels 326 (like the inflatable chambers 80, 90 in other embodiments herein) provide improved support, height, and some degree of buoyancy to patient transporter 310.

For orientation, patient transporter 310 in FIGS. 34A and 34B has gripping devices 370 around the perimeter of upper substrate 320, and a backing substrate 322 that forms the bottom (back) side of upper substrate 320.

FIG. 34B shows absorbent body 324 disposed on the top (front) side of backing substrate 322. Absorbent body 324 is sized somewhat less than backing substrate 322, so that a portion of backing substrate 322 forms an edge about a portion of absorbent body 324. Pocket 360 is provided on the front side of patient transporter 310. A binding 359 is connected along both lengthwise edges to provide a finished appearance and strength to patient transporter 310.

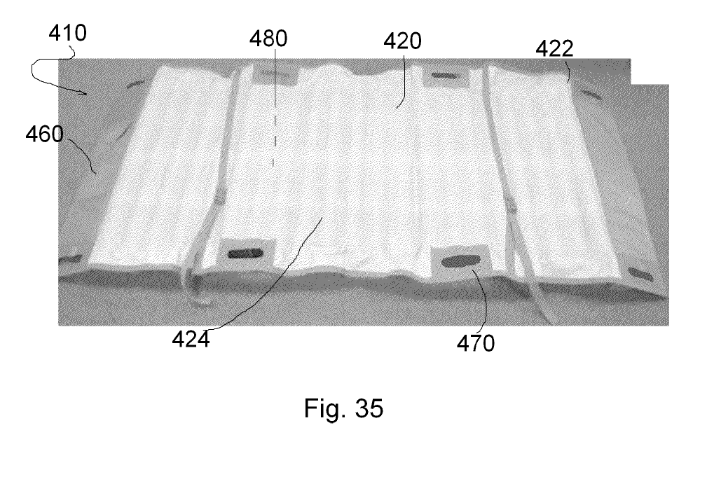

FIG. 35 is another exemplary embodiment of a patient transporter of the present disclosure, represented generally by reference numeral 410. Patient transporter 410 has a plurality of inflatable chambers 480 that are formed within, and integral to, upper substrate 420. In FIG. 35, inflatable chambers 480 are in a horizontal (perpendicular) orientation relative to the direction of a patient's body on patient transporter 410. An absorbent body 424 is disposed on a backing substrate 422 to form part, or all, of the top surface of patient transporter 410. Backing substrate 422, which forms the bottom surface of this embodiment of patient transporter 410, can be folded over the top side at both ends of the transporter to form a part of the top surface as well. Gripping devices 470 and pocket 460 are also provided for orientation.

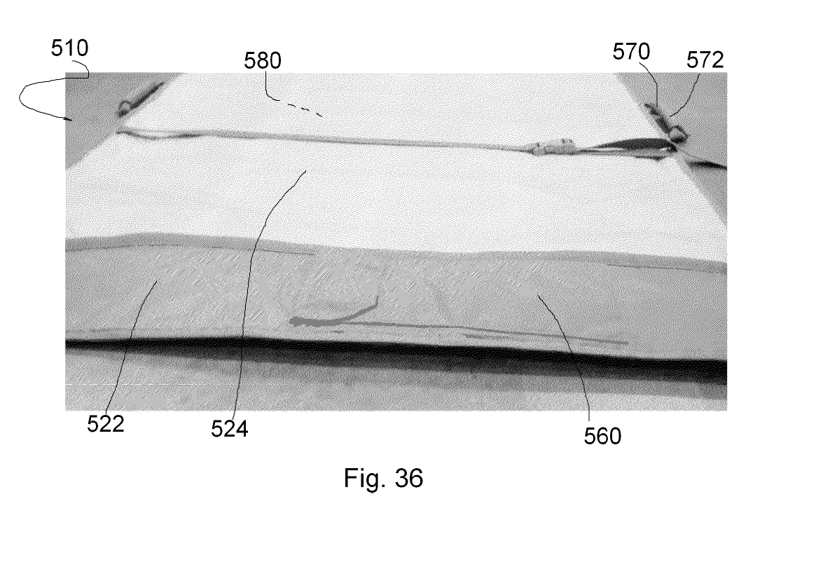

FIG. 36 is another exemplary embodiment of a patient transporter of the present disclosure, represented generally by reference numeral 510. Patient transporter 510 has a plurality of inflatable chambers 580 that are in (and integral to) upper substrate 520. In FIG. 36, inflatable chambers 580 are shown in an uninflated condition. In this embodiment, gripping devices 570 are handles formed by loops of straps connected to a bottom surface of patient transporter 510, rather than pass-through holes in previous embodiments herein). Gripping devices 570 can be padded or reinforced by extra material 572. Patient transporter 510 has a backing substrate 522 and an absorbent body 524 (that is disposed upon backing substrate 522) that form the top surface of patient transporter 510. Pocket 560 is labeled for reference.

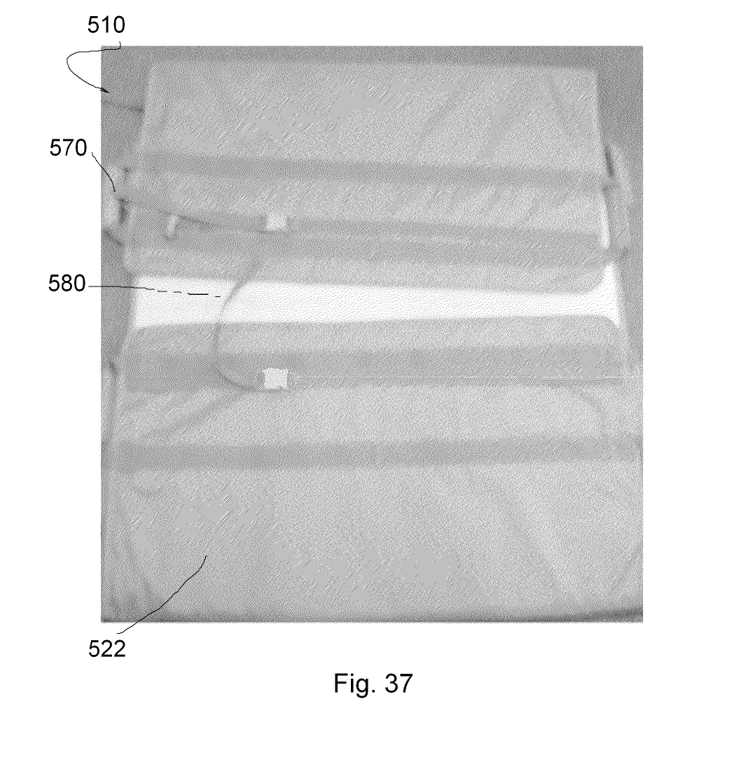

FIG. 37 shows patient transporter 510 in FIG. 36, folded over to illustrate the exceptional flexibility and portability of the patient transporter prior to being inflated for use. Backing substrate 522, absorbent body 524, and inflatable chambers 580 are labeled for orientation.

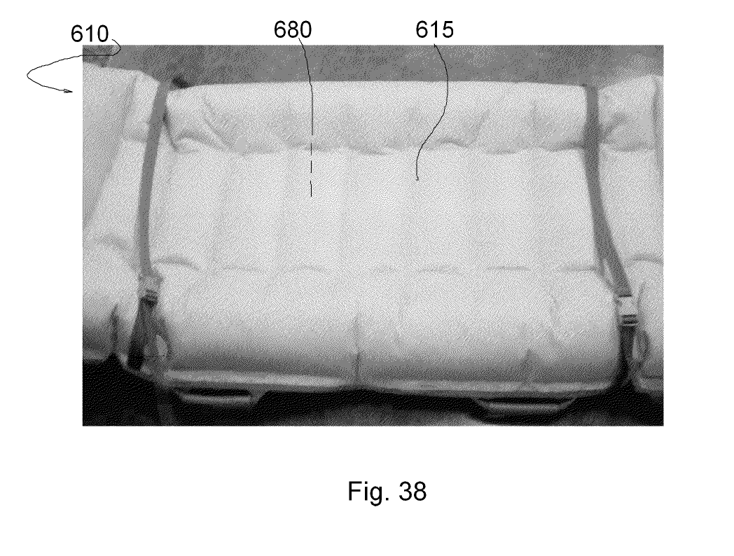

FIG. 38 is another exemplary embodiment of a patient transporter of the present disclosure, represented generally by reference numeral 610. Patient transporter 610 has a plurality of inflatable chambers 680 disposed beneath a top surface 615 of transporter 610. Patient transporter 610 has one or more inflation zones that can be inflated to different levels, forming zones that provide greater or lesser support for different areas of the patient's body, thereby enhancing patient safety and comfort during transport. For example, inflation chambers 680 located under the head and neck areas of the transporter can be made of a material permitting greater expansion, and/or inflated to a greater air pressure, to provide a cushion and slight elevation for the head and neck in relation to the rest of the patient's body. Inflation chambers 680 can also be arranged to form a raised edge around the perimeter (when inflated) of the transporter, to keep the patient stable along a center axis of the transporter and increase the patient's sense of security and well-being during transport, as well as protect top surface 615 from contamination by the ground or water.

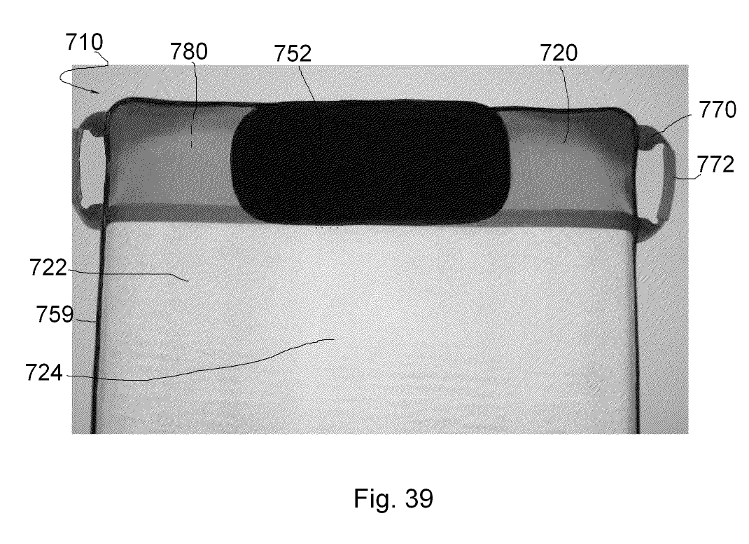

FIG. 39 is another exemplary embodiment of a patient transporter of the present disclosure, represented generally by reference number 710. Patient transporter 710 has a head support 752 that is disposed on a top surface 722 of upper substrate 720 within the main (rectangular) footprint of patient transporter 710. Head support 752 is supported by inflatable chambers 780 that extend across the entire width of patient transporter 710. Absorbent body 724 also forms a part of upper substrate 720. One or more gripping handles 770 (with extra padding 772) are formed from loops of straps connected to the underside of patient transporter 710. Binding 759 provides a finished appearance and additional strength where the upper and lower substrates are connected.

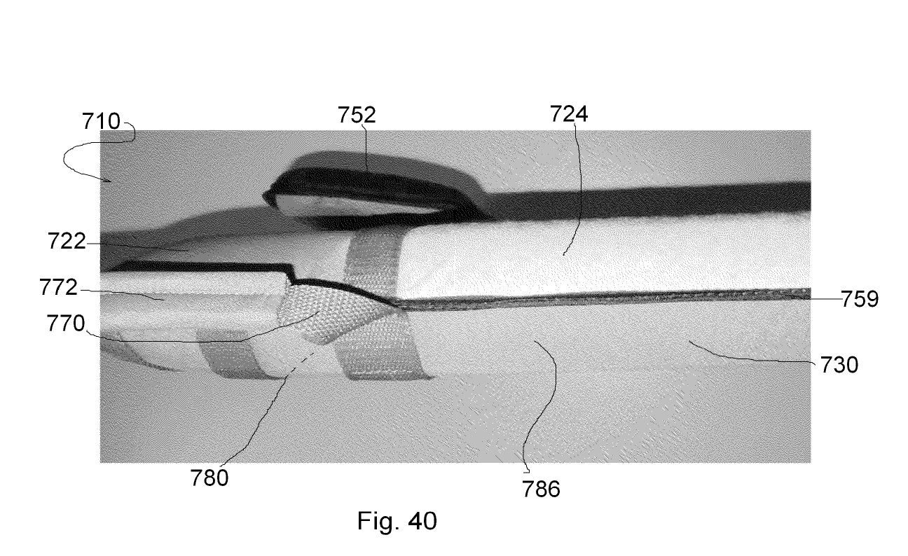

FIG. 40 shows head support 752 of patient transporter 710 disposed on top surface 722 of upper substrate 720. Lower substrate 730 has an exterior cover 786 that forms pocket 788 to completely enclose one or more inflatable chambers 780 placed in a horizontal or vertical configuration. In FIG. 39, inflatable chambers 780 are inflated. Absorbent body 724 also forms part of upper substrate 720. One or more gripping handle 770 (with extra padding 772) is formed from a loop of a strap that is connected to exterior cover 786. Binding 759 provides a finished appearance and additional strength to patient transporter 710.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances that fall within the scope of the disclosure.

1. A transporter for carrying an injured or ill person, comprising:
a discrete upper substrate having a top side and a bottom side;
a discrete lower substrate connected to said bottom side of said upper substrate, said lower substrate comprising an inflatable chamber that extends across a major portion of a length or width of said transporter; and
one or more gripping devices around the perimeter of said transporter,
wherein said inflatable chamber provides rigidity to the transporter when inflated to support the person carried thereon, and minimizes any adverse effects of the injury or illness during transport.

2. The transporter according to claim 1, wherein said upper substrate is non-inflatable.

3. The transporter according to claim 1, wherein said upper substrate and said lower substrate are connected at one or more seal points, and wherein said one or more seal points form pleats that provide additional support to the transporter.

4. The transporter according to claim 1, wherein said upper substrate and said lower substrate are removably connected.

5.-6. (canceled)

7. The transporter according to claim 1, wherein said inflatable chamber is a plurality of inflatable chambers.

8.-11. (canceled)

12. The transporter according to claim 1, wherein said inflatable chamber comprises:
a double-walled material sealed around its periphery to form an air cavity therein, said double-walled material having a plurality of internal attachment fibers traversing the air cavity therein,
wherein said plurality of internal attachment fibers extend between an interior surface of each wall of said double-walled material, thereby constraining the expansion of said inflatable chamber during inflation to regulate the rigidity and flexibility of said inflatable chamber.

13. The transporter according to claim 1, wherein said inflatable chamber comprises a fill valve through which a gas is injected to inflate said inflatable chamber.

14.-15. (canceled)

16. The transporter according to claim 7, wherein said plurality of inflatable chambers are configured in said lower substrate to provide uniform support for all areas of the transporter when said plurality of inflatable chambers are inflated.

17. The transporter according to claim 7, wherein said plurality of inflatable chambers are configured in said lower substrate in separate inflation zones that can be inflated to different levels of rigidity and flexibility, to provide customized support for different body areas of the person carried thereon during transport.

18. The transporter according to claim 1, wherein said inflatable chamber, when inflated, provides support to the transporter to yield a deflection value between about three inches (7.6 cm) to about 5 inches (12.7 cm) from horizontal when a patient is carried thereon during transport.

19. (canceled)

20. The transporter according to claim 13, wherein said gas is stored in a container prior to use, and wherein said container comprises a connector that can be removably connected to said fill valve for rapid inflation of said inflatable chamber.

21.-22. (canceled)

23. The transporter according to claim 13, further comprising a ripcord device that activates said injection of gas into said inflatable chamber.

24.-25. (canceled)

26. The transporter according to claim 1, wherein said inflation chamber further comprises:
one or more air channels that extend across a major portion of the transporter,
wherein said one or more air channels are formed in a space between parallel seams connecting an upper portion and a lower portion of said upper substrate.

27. The transporter according to claim 1, further comprising an exterior cover connected to said bottom side of said upper substrate to form a pocket that encloses said inflatable chamber.

28.-29. (canceled)

30. The transporter according to claim 1, further comprising:
an absorbent body disposed on said top side of said upper substrate,
wherein said absorbent body is made of one or more layers of an absorbent material, and
wherein said one or more layers of absorbent material can absorb about 4.5 liters of a body fluid or other liquid.

31. The transporter according to claim 30, wherein said absorbent body is removably connected to said top side of said upper substrate.

32. (canceled)

33. The transporter according to claim 30, wherein said absorbent body further comprises an active agent, wherein said active agent is selected from the group consisting of: bactericide, bacteriostatic agent, fungicide, virucide, disinfectant, sanitizer, sterilizer, mildewstat, surfactant, deodorizer, and any combinations thereof.

34. The transporter according to claim 1, further comprising:
a top cover connected to said upper substrate,
wherein said top cover comprises a closure that opens and closes said top cover about the person carried on the transporter.

35. (canceled)

36. The transporter according to claim 34, wherein said top cover further comprises a cut-out opening, wherein said cut-out opening is sized to fit snugly about the person's face and head during transport.

37. (canceled)

38. The transporter according to claim 34, wherein said top cover further comprises one or more layers of a material selected from the group consisting of: insulating material, thermal liner, reflective interior surface, and any combinations thereof, said material retaining the person's body heat to reduce adverse events from hypothermia.

39. (canceled)

40. The transporter according to claim 1, said lower substrate further comprising:
a skid plate, wherein said skid plate covers a portion of an outer surface of said lower substrate to provide a smooth sliding surface when the transporter with a person thereon is pulled across the ground.

41. The transporter according to claim 1, wherein the transporter is metal-free, to avoid detection of the transporter.

42. The transporter according to claim 1, wherein the transporter is foldable or rollable to a small size that permits storage of the transporter in a canister or rucksack when said inflatable chamber is not inflated.

43. The transporter according to claim 1, further comprising:
a hinged support assembly connected to said lower substrate of the transporter, said hinged support assembly comprising:
a hinge; and
two or more solid segments connected to said hinge,
wherein said hinged support assembly provides additional rigidity and support to the transporter.

44.-47. (canceled)

48. The transporter according to claim 43, wherein said hinged support assembly is a first hinged support assembly connected to a second hinged support assembly by a cross-segment extending between said solid segments of each hinged support assembly to form a dual hinged support assembly, and wherein said dual hinged support assembly is connected to the lower substrate to provide additional support and rigidity to the transporter.

49. (canceled)

50. A method of using a transporter having an inflatable chamber for carrying an injured or ill person, comprising:
placing the transporter on a flat surface, the transporter comprising:
a discrete upper substrate having a top side and a bottom side;
a discrete lower substrate connected to said bottom side of said upper substrate, said lower substrate comprising an inflatable chamber that extends across a major portion of a length or width of said transporter; and
one or more gripping devices around the perimeter of said transporter;
inflating said inflatable chamber;
placing an injured or ill person on the top side of said upper substrate;
lifting the transporter from said flat surface by said one or more gripping devices; and
carrying the injured or ill person on the transporter,
wherein said inflatable chamber provides rigidity and support to the transporter, and thereby minimizes any adverse effects of the injury or illness of the person carried thereon during transport.

51. The method according to claim 50, further comprising:
connecting a hinged support assembly to said lower substrate prior to said placing the person on said top side of said upper substrate,
wherein said hinged support assembly provides additional rigidity and support to the transporter.
